(19) United States
(12) Patent Application Publication
(10) Pub. No.: US 2025/0130871 A1
(43) Pub. Date: Apr. 24, 2025

(54) METHODS AND SYSTEMS FOR APPLICATION DISCOVERY FROM LOG MESSAGES

(71) Applicant: VMware, Inc., Palo Alto, CA (US)

(72) Inventors: Ashot Nshan Harutyunyan, Yerevan (AM); Arnak Poghosyan, Yerevan (AM); Tigran Bunarjyan, Yerevan (AM); Andranik Haroyan, Yerevan (AM); Marine Harutyunyan, Yerevan (AM); Litit Harutyunyan, Yerevan (AM); Ashot Baghdasaryan, Yereyan (AM)

(73) Assignee: VMware, Inc., Palo Alto, CA (US)

(21) Appl. No.: 18/381,520

(22) Filed: Oct. 18, 2023

(51) Int. Cl. G06F 9/54; G06F 9/451; G06F 17/18

(52) U.S. Cl. CPC G06F 9/542; G06F 9/451; G06F 17/18

(57) ABSTRACT

This disclosure is directed to automated computer-implemented methods for application discovery from log messages generated by event sources of applications executing in a cloud infrastructure. The methods are executed by an operations manager that constructs a data frame of probability distributions of event types of the log messages generated by the event sources in a time period. The operations manager executes clustering techniques that are used to form clusters of the probability distributions in the data frame, where each of the clusters corresponds to one of the applications. The operations manager displays the clusters of the probability distributions in a two-dimensional map of applications in a graphical user interface that enables a user to select one of the clusters in the map of applications that corresponds to one of the applications and launch clustering of probability distributions of the user-selected cluster to discover two or more instances of the application.

### TECHNICAL FIELD

This disclosure is directed to application discovery in a cloud infrastructure.

### BACKGROUND

Electronic computing has evolved from primitive, vacuum-tube-based computer systems, initially developed during the 1940s, to modern electronic computing systems with large numbers of multi-processor computer systems, such as server computers and workstations, are networked together with large-capacity data-storage devices to produce geographically distributed computing systems that provide enormous computational bandwidths and data-storage capacities. These large, distributed computing systems include data centers and are made possible by advancements in virtualization, computer networking, distributed operating systems and applications, data-storage appliances, computer hardware, and software technologies. The data center hardware, virtualization, abstracted resources, data storage, and network resources combined form a cloud infrastructure that is used by organizations, such as governments and ecommerce businesses, to run applications that provide business services, web services, streaming services, and other cloud services to millions of users each day.

Advancements in virtualization, networking, and other distributed computing technologies have paved the way for scaling of applications in response to user demand. The applications can be monolithic applications or distributed applications. A typical monolithic application is single-tiered software in which the user interface, application programming interfaces, data processing, and data access code are implemented in a single program that is run on a single platform, such as a virtual machine (“VM”) or in a container also called an object. As demand increases, the number of monolithic applications deployed in a cloud infrastructure is scaled up accordingly. Alternatively, distributed applications can be run with independent application components, called microservices. Each microservice has its own logic and database and performs a single function or provides a single service and is deployed in a virtual object. Separate microservices are executed in VMs or containers and are scaled up to meet increasing demand for services.

As modern multi-cloud environments advance rapidly with ever-growing complexities and with the increase in the myriad of different ways in which applications can be scaled and deployed in a cloud environment, applications are now spread across hybrid multi-cloud environments stretching from the data center to multiple clouds and the edge, creating a complex web of application dependencies. As a result, it has become increasingly challenging for application owners and systems administrators to accurately define highly dynamic application boundaries and know which applications are running.

In recent years, application discovery (“AD”) services have been developed to aid with AD using a combination of workload naming conventions, workload tags, security tags, and groups to establish application boundaries. Other AD services incorporate agent-based AD methodologies that capture system configuration, system performance, running processes, and details of the network connections between systems. These AD services gather and process information corresponding to server hostnames, IP addresses as well as resource allocation and utilization details related to VM inventory, configuration, and performance history such as CPU, memory, and disk usage data. Still other AD services employ a flow-based discovery approach to groups of application components based on runtime behaviors. However, these AD services are generally not capable of accurately capturing the application components, such as VMs in development, production, and staging environments of an application that are isolated in a network. Although these AD services address a variety of significant specific use cases in AD, existing AD services are limited and not applicable across the variety of different and complex cloud environments that applications are now executed in. Application owners and systems administrators seek more reliable AD services that are more accurate and can be used for AD in a wide variety of evolving cloud environments.

### SUMMARY

This disclosure is directed to automated computer-implemented methods for application discovery from log messages generated by event sources of applications executing in a cloud infrastructure. The methods are executed by an operations manager executed on a server computer to construct a data frame of probability distributions of event types of the log messages generated by the event sources in a time period. Each of the probability distributions contains the probabilities of event types generated by the event sources in a subinterval of the time period. The operations manager executes clustering techniques that are used to form clusters of the probability distributions in the data frame, where each of the clusters corresponds to one of the applications. The operations manager displays an interactive graphical user interface (“GUI”) on a display device. The GUI displays the clusters of the probability distributions in a two-dimensional map of the applications, enables a user to select one of the clusters in the map that corresponds to one of the applications, and launch clustering of probability distributions of the user-selected cluster to discover two or more instances of the application. The operations manager executes operations that improve performance of at least one of the two or more instances of the application that correspond to different workloads. The operations include migrating the instance of the application to a server computer that has more computational resources than the server computer the instance of the application is executing on.

### DESCRIPTION OF THE DRAWINGS

FIG. 1 shows an architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machines (“VMs”) and VM execution environments.

FIG. 6 shows an example of an open virtualization format package.

FIG. 7 shows examples of virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing containers on a VM.

FIG. 13 shows an example of a cloud infrastructure.

FIG. 14 shows an example of logging log messages in log files.

FIG. 15 shows an example source code of an event source.

FIG. 16 shows an example of a log write instruction.

FIG. 17 shows an example of a log message generated by the log write instruction in FIG. 16.

FIG. 18 shows a small, eight-entry portion of a log file.

FIG. 19A shows a table of examples of regular expressions designed to match particular character strings of log messages.

FIG. 19B shows a table of examples of primary Grok patterns and corresponding regular expressions.

FIG. 19C shows an example of a Grok expression used to extract tokens from a log message.

FIG. 20 shows construction of example probability distribution from log messages of an object produced in a subinterval of a time period.

FIG. 21 shows an example of a data frame of probability distributions.

FIG. 22 shows an example matrix of distances calculated for each pair of probability distributions in the data frame.

FIG. 23 shows an example dendrogram constructed from probability distributions in the data frame.

FIGS. 24A-24M show an example of hierarchical clustering applied to seven probability distributions.

FIG. 25 shows an example dendrogram with clusters of probability distributions.

FIG. 26 is a flow diagram of a method for performing t-distributed stochastic neighbor embedding for probability distributions in the data frame.

FIG. 27 shows an example plot of points in a map of applications obtained from t-SNE on a set of probability distributions.

FIG. 28 shows an example of a neighborhood of a point in a map of applications.

FIGS. 29A-29C show examples of a core point, a border point, and noise, respectively.

FIG. 30 shows an example of a density reachable point.

FIG. 31 shows an example plot of three clusters of points.

FIGS. 32-36 show an example of a graphical user interface (“GUI”) that enables a user to execute the automated methods of application discovery.

### DETAILED DESCRIPTION

This disclosure presents automated computer-implemented methods and systems for application discovery (“AD”) from log messages of objects executing in a cloud environment. Computer hardware, complex computational systems, and virtualization are described are described in the first subsection. Computer-implemented methods and systems for automated AD from log messages are described below in the second subsection.

### Computer Hardware, Complex Computational Systems, and Virtualization

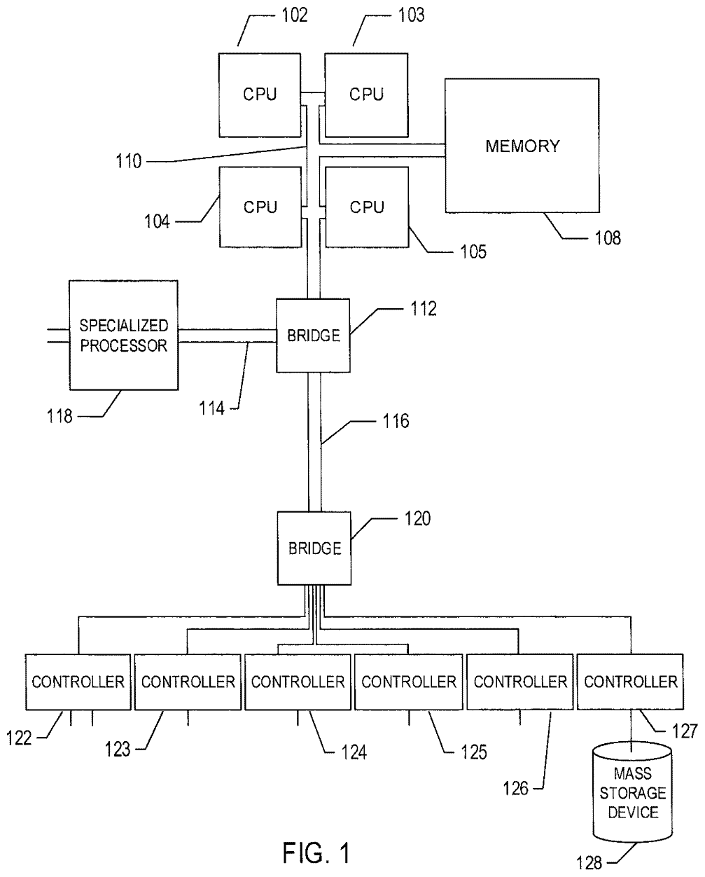

FIG. 1 shows a general architectural diagram for various types of computers. Computers that receive, process, and store log messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

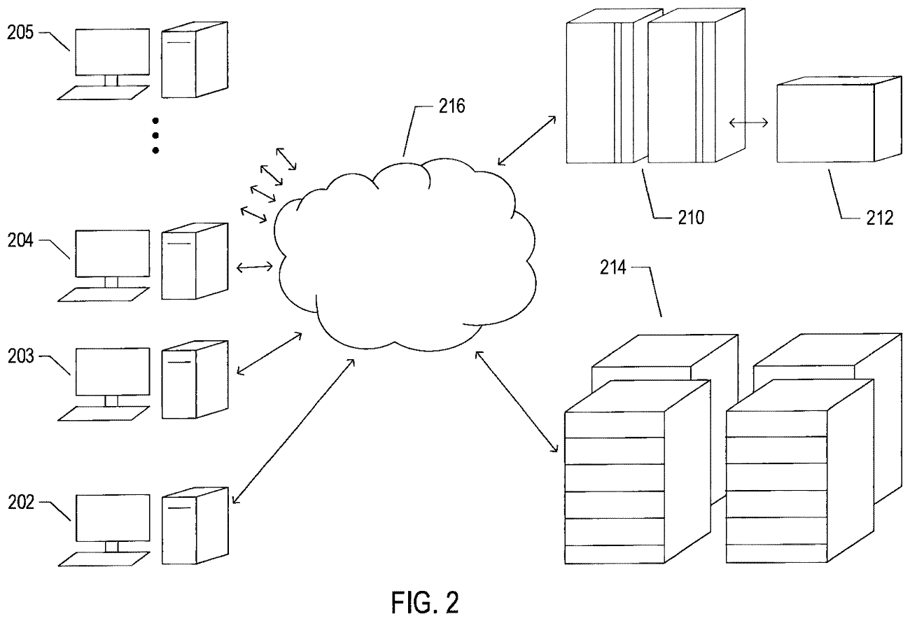

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web server computers, back-end computer systems, and data-storage systems for serving web pages to remote customers, receiving orders through the web-page interface, processing the orders, tracking completed orders, and other myriad different tasks associated with an e-commerce enterprise.

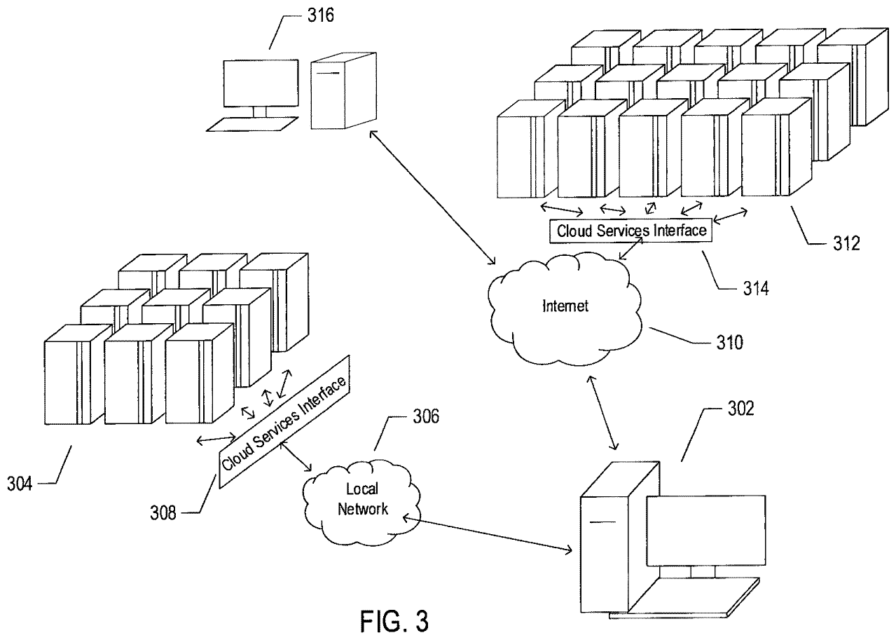

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

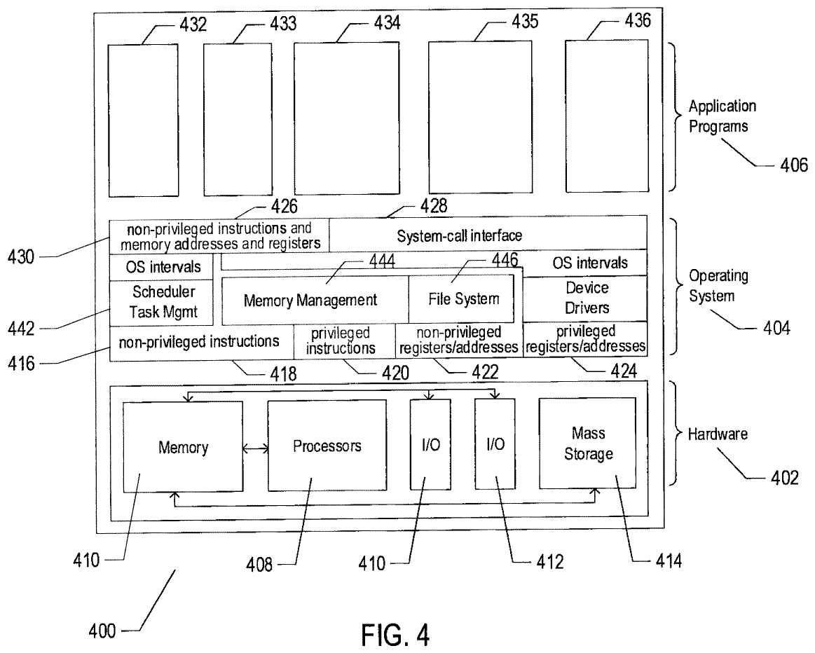

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

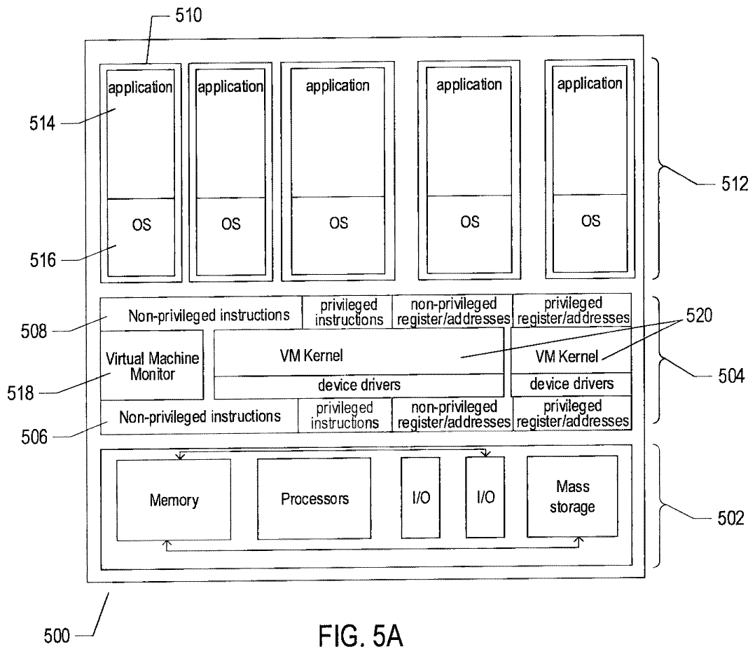

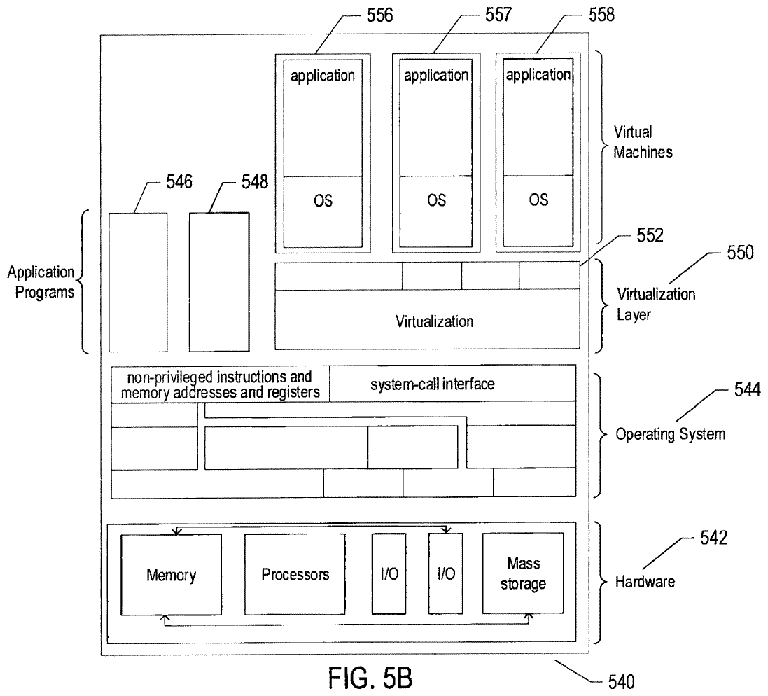

For all of these reasons, a higher level of abstraction, referred to as the “virtual machine,” (“VM”) has been developed and evolved to further abstract computer hardware in order to address many difficulties and challenges associated with traditional computing systems, including the compatibility issues discussed above. Figures SA-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtualization layer 504 that interfaces through a virtualization-layer/hardware-layer interface 506, equivalent to interface 416 in FIG. 4, to the hardware. The virtualization layer 504 provides a hardware-like interface to VMs, such as VM 510, in a virtual-machine layer 511 executing above the virtualization layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization layer interface 504 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization layer 504 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture, The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization layer 504, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The hardware-layer interface 552, equivalent to interface 416 in FIG. 4, provides an execution environment for a number of VMs 556-558, each including one or more application programs or other higher-level computational entities packaged together with a guest operating system.

In Figures SA-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

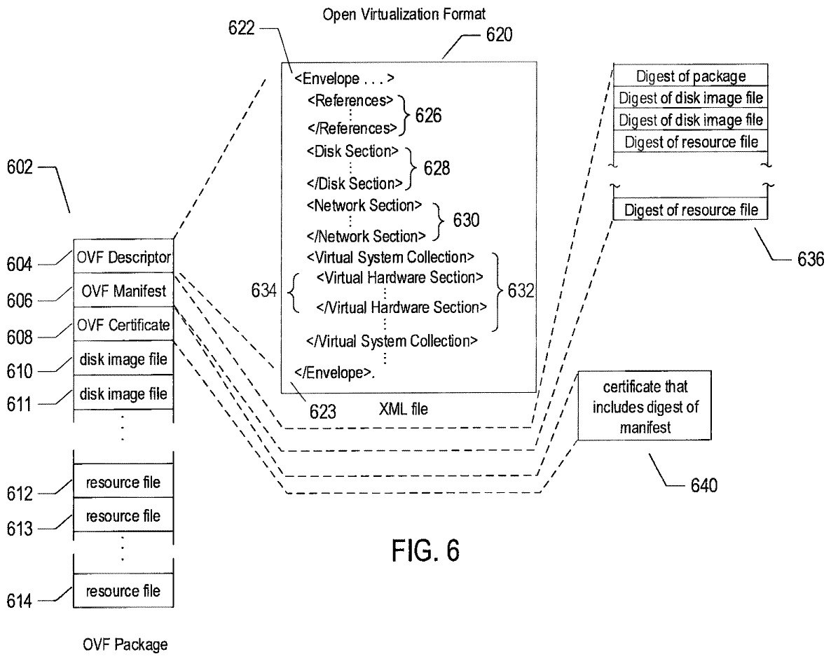

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a network section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of various different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712. 724, and 726 that each directly interconnects a bank of eight server computers and a mass-storage array. The individual server computers, such as server computer 710, include a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of server computers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server computer 706 includes functionality to migrate running VMs from one server computer to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual server computers and migrating VMs among server computers to achieve load balancing, fault tolerance, and high availability).

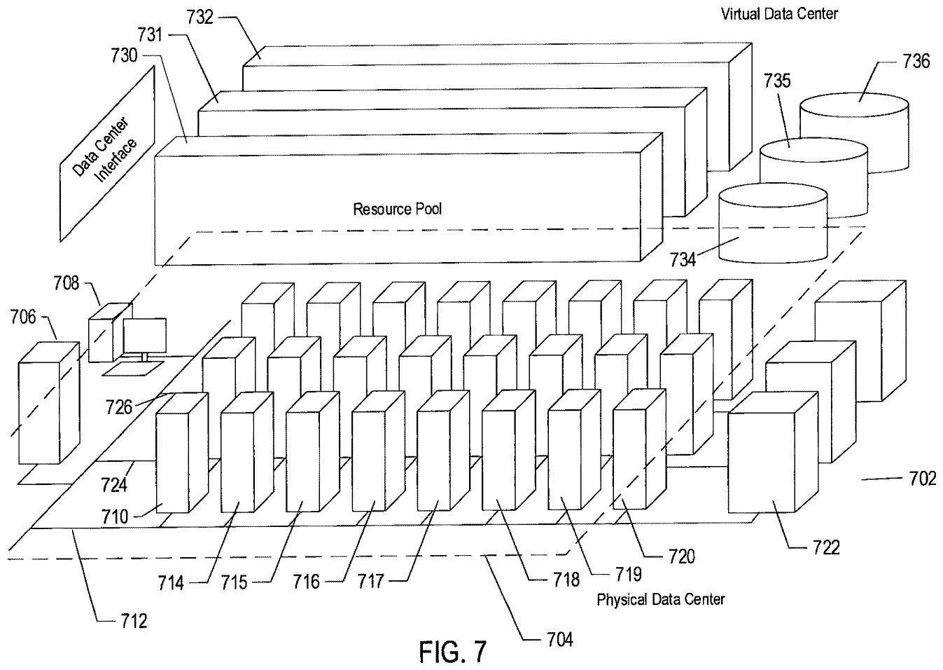

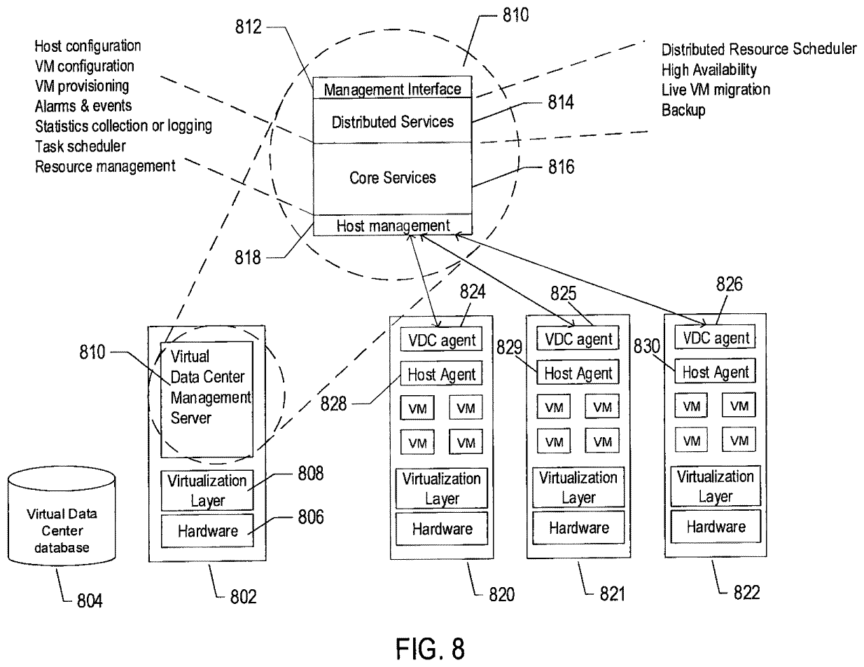

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtualization layer 808 and runs a virtual-data-center management-server VM 810 above the virtualization layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer, and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtualization layer can be accessed via a virtual-infrastructure application programming interface (“API”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents, monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant associated VDCs that can each be allocated to an individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

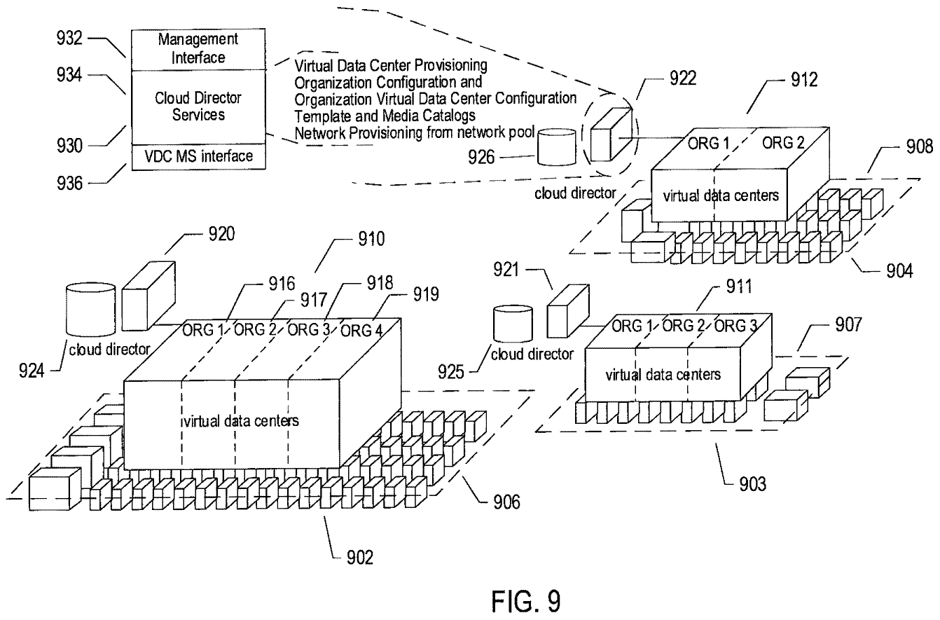

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director server computers 920-922 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

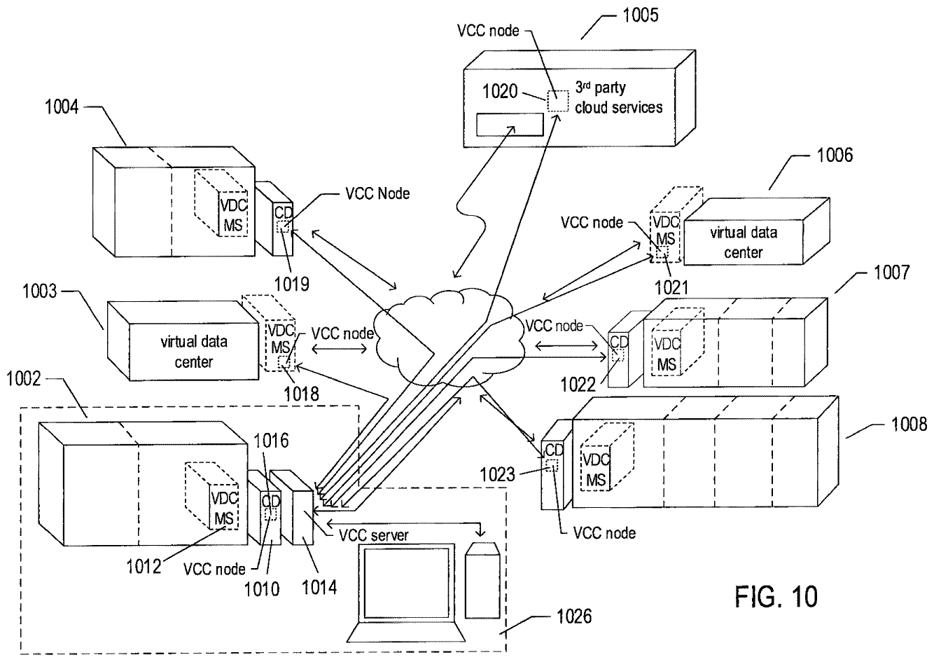

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal. PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

As mentioned above, while the virtual-machine-based virtualization layers, described in the previous subsection, have received widespread adoption and use in a variety of different environments, from personal computers to enormous, distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

While a traditional virtualization layer can simulate the hardware interface expected by any of many different operating systems, OSL virtualization essentially provides a secure partition of the execution environment provided by a particular operating system. A container is an abstraction at the application layer that packages code and dependencies together. Multiple containers can run on the same computer system and share the operating system kernel, each container running as an isolated process in the user space. One or more containers are run in pods. For example, OSL virtualization provides a the system to each container, but the file system provided to the container is essentially a view of a partition of the general file system provided by the underlying operating system of the host. In essence, OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. The containers are isolated from one another and bundle their own software, libraries, and configuration files within in the pods. A container cannot access files that are not included in the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtualization layers. Again, however, OSL virtualization does not provide many desirable features of traditional virtualization. As mentioned above, OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies.

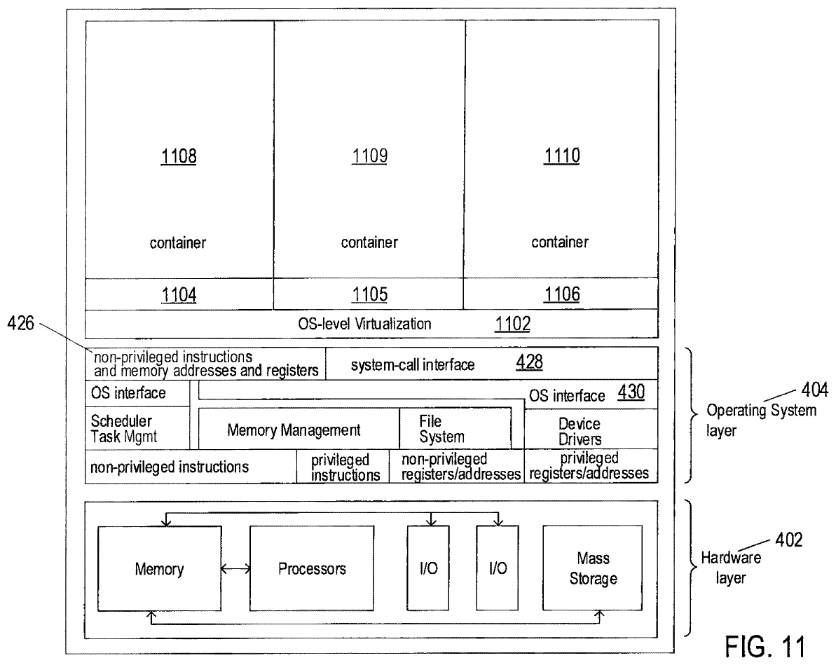

FIG. 11 shows an example server computer used to host three pods. As discussed above with reference to FIG. 4, an operating system layer 404 runs on the hardware layer 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly on the operating system layer 404. OSL virtualization involves an OSL virtualization layer 1102 that provides operating-system interfaces to each of the pods 1-3. In this example, applications are run separately in containers 1-6 that are in turn run in pods identified as Pod 1, Pod 2, and Pod 3. Each pod runs one or more containers with shared storage and network resources, according to a specification for how to run the containers. For example, Pod 1 runs an application 1104 in container 1 and another application 1106 in a container identified as container 2.

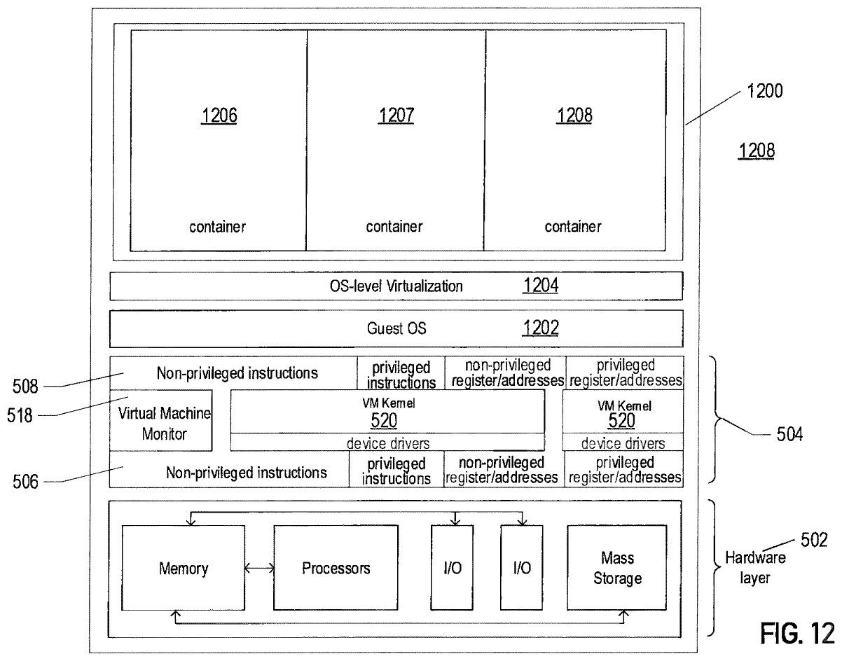

FIG. 12 shows an approach to implementing the containers in a VM. FIG. 12 shows a host computer similar to that shown in FIG. 5A, discussed above. The host computer includes a hardware layer 502 and a virtualization layer 504 that provides a virtual hardware interface 508 to a guest operating system 1202. Unlike in FIG. 5A, the guest operating system interfaces to an OSL-virtualization layer 1204 that provides container execution environments 1206-1208 to multiple application programs.

Note that, although only a single guest operating system and OSL virtualization layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtualization layers to provide containers for running applications is referred to, in the following discussion, as a “hybrid virtualized distributed computing system.”

Running containers above a guest operating system within a VM provides advantages of traditional virtualization in addition to the advantages of OSL virtualization. Containers can be quickly booted in order to provide additional execution environments and associated resources for additional application instances. The resources available to the guest operating system are efficiently partitioned among the containers provided by the OSL-virtualization layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling, and other such features. Containers provide share-based allocation of computational resources to groups of applications with guaranteed isolation of applications in one container from applications in the remaining containers executing above a guest operating system. Moreover, resource allocation can be modified at runtime between containers. The traditional virtualization layer provides for flexible and scaling over large numbers of hosts within large, distributed computing systems and a simple approach to operating-system upgrades and patches. Thus, the use of OSL virtualization above traditional virtualization in a hybrid virtualized distributed computing system, as shown in FIG. 12, provides many of the advantages of both a traditional virtualization layer and the advantages of OSL virtualization.

### Operations Manager and Log Messages

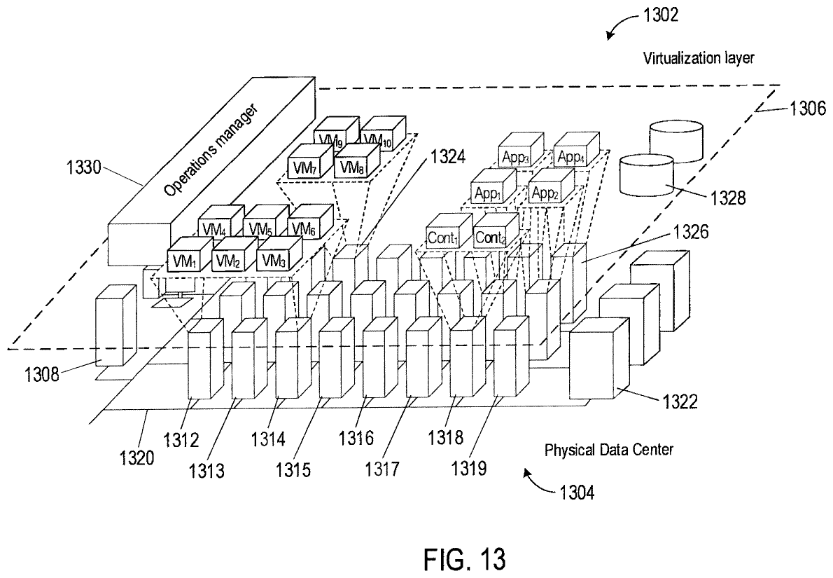

FIG. 13 shows an example of a cloud infrastructure composed of a virtualization layer 1302 located above a physical data center 1304. For the sake of illustration, the virtualization layer 1302 is separated from the data center 1304 by a virtual-interface plane 1306. The data center 1304 is an example of a distributed computing system. The data center 1304 comprises an administration computer system 1308, any of various computers, such as PC 1310, on which a virtual data center (“VDC”) management interface may be displayed to system administrators and other users, server computers, such as server computers 1312-1319, data-storage devices, and network devices. Each server computer may have multiple network interface cards (“NICs”) to provide high bandwidth and networking to other server computers and data storage devices. The server computers are networked together to form server-computer groups within the data center 1304. The example physical data center 1304 includes three server-computer groups each of which have eight server computers. For example, server-computer group 1320 comprises interconnected server computers 1312-1319 that are connected to a mass-storage array 1322. Within each server-computer group, certain server computers are grouped together to form a cluster that provides an aggregate set of resources (i.e., resource pool) applications executing in the virtualization layer 1302.

The virtual-interface plane 1306 abstracts the resources of the physical data center 1304 to one or more objects, such as applications, VMs, and containers, and one or more virtual data stores, such as virtual data store 1328. For example, one VDC may comprise the VMs running on server computer 1324 and virtual data store 1328. The objects in the virtualization layer 1302 are hosted by the server computers in the physical data center 1304. The virtualization layer 1302 may also include a virtual network (not illustrated) of virtual switches, routers, load balancers, and NICs formed from the physical switches, routers, and NICs of the physical data center 1304. Certain server computers host VMs and containers as described above. For example, server computer 1318 hosts two containers identified as Cont₁ and Cont₂; cluster of server computers 1312-1314 host six VMs identified as VM₁, VM₂, VM₃, VM₄, VM₅, and VM₆; server computer 1324 hosts four VMs identified as VM₇, VM₈, VM₉, VM₁₀. Other server computers may host standalone applications as described above with reference to FIG. 4. For example, server computer 1326 hosts application App₄.

For the sake of illustration, the data center 1304 and virtualization layer 1302 are shown with a small number of computer servers and objects. In practice, a typical data center runs thousands of server computers that are used to run thousands of VMs and containers. Different data centers may include many different types of computers, networks, data-storage systems, and devices connected according to many different types of connection topologies.

Computer-implemented methods described herein are performed by an operations manager 1330 that is executed on the administration computer system 1308. The operations manager 1330 performs application discovery (“AD”) from log messages of the objects executing in the data center. The operations manager 1330 identifies similar groups of objects based on hierarchical and density-based clustering of relevant event types of the log message sources over an aggregated time interval.

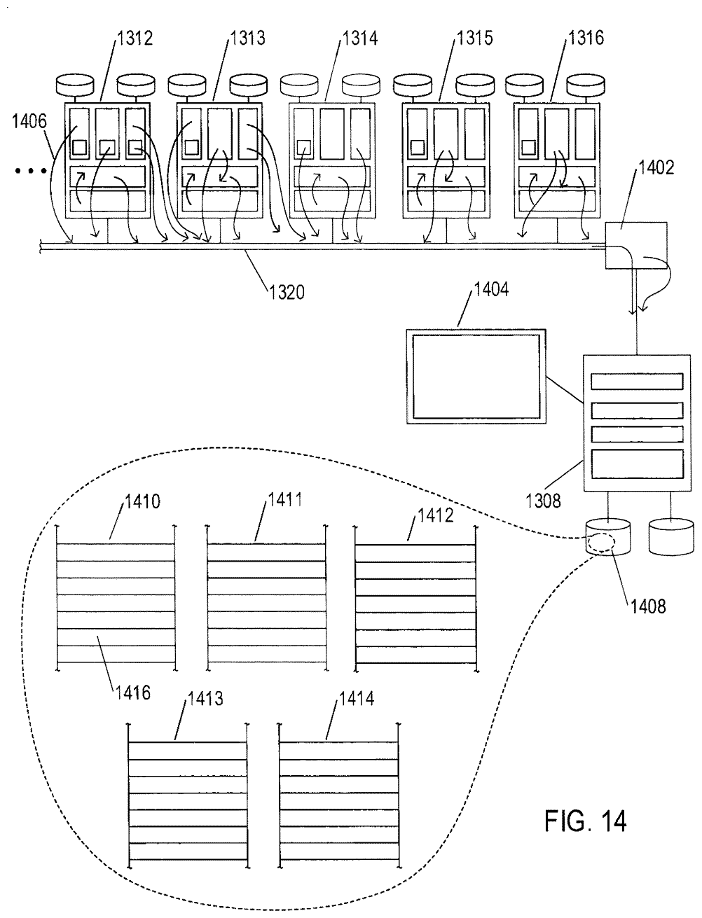

FIG. 14 shows an example of logging log messages in log files. In FIG. 14, computer systems 1312-1316 of the distributed computing system in FIG. 13 are linked together by the electronic communications medium 1320 and additionally linked through a communications bridge/router 1402 to the administration computer system 1308 that includes an administrative console 1404. Each of the computer systems 1312-1316 runs an OTL library and an OTL agent with a corresponding microservice as described above. The OTL agents forward log messages to the operations manager 1330 executing on the administration computer system 1308. As indicated by curved arrows, such as curved arrow 1406, multiple components within each of the discrete computer systems 1312-1316 as well as the communications bridge/router 1402 generate log messages that are forwarded to the operations manager 1330. Log messages may be generated by any event source. Event sources may be, but are not limited to, applications, microservices, operating systems. VMs, guest operating systems, containers, network devices, machine codes, event channels, and other computer programs or processes running on the computer systems 1312-1316, the bridge/router 1402 and any other components of a data center. Log messages may be received by OTL agents at various hierarchical levels within a discrete computer system and then forwarded to the forwarder in the operations manager 1330 executing in the administration computer system 1308. The operations manager 1330 records the log messages in a data storage device or appliance 1408 as log files 1410-1414. Rectangles, such as rectangle 1416, represent individual log messages. Each OTL agent has a configuration that includes a log path and a log parser.

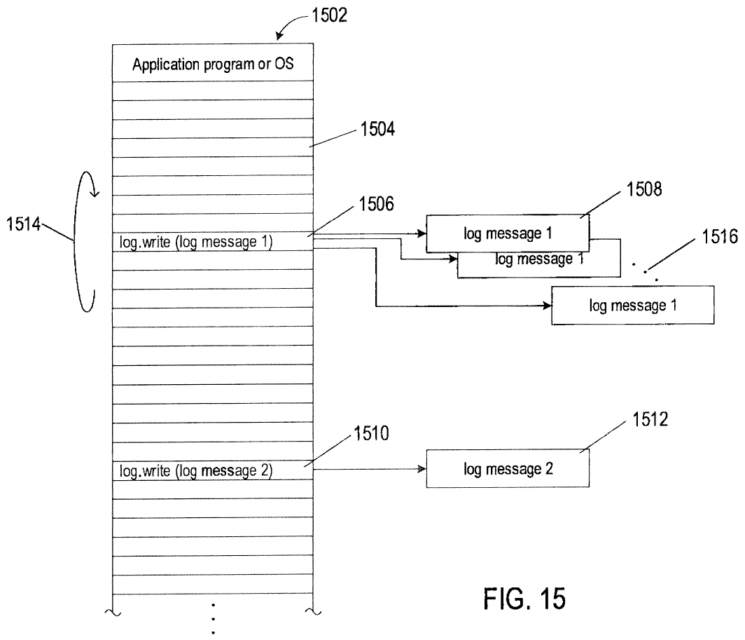

FIG. 15 shows an example source code 1502 of an event source, such as an application, an operating system, a VM, a guest operating system, or any other computer program or machine code that generates log messages. The source code 1502 is just one example of an event source that generates log messages. Rectangles, such as rectangle 1504, represent a definition, a comment, a statement, or a computer instruction that expresses some action to be executed by a computer. The source code 1502 includes log write instructions that generate log messages when certain events predetermined by a developer occur during execution of the source code 1502. For example, the source code 1502 includes an example log write instruction 1506 that when executed generates a “log message 1” 1508, and a second example log write instruction 1510 that when executed generates “log message 2” 1512. In the example of FIG. 15, the log write instruction 1508 is embedded within a set of computer instructions that are repeatedly executed in a loop 1514. As shown in FIG. 15, the same log message 1 is repeatedly generated 1516. The same type of log write instructions may also be located in different places throughout the source code, which in turn creates repeats of essentially the same type of event recorded in multiple log messages in the log file.

In FIG. 15, the notation “log.write( )” is a general representation of a log write instruction. In practice, the form of the log write instruction varies for different programming languages. In general, the log write instructions are determined by the developer. Log write instructions are unstructured, or semi-structured, and relatively cryptic. For example, log write instructions may include instructions for time stamping the log message and contain a message comprising natural-language words and/or phrases as well as various types of text strings that represent file names, path names, and perhaps various alphanumeric parameters that may identify objects, such as VMs, containers, or virtual network interfaces. In practice, a log write instruction may also include the name of the source of the log message (e.g., name of the application program, operating system and version, server computer, and network device) and may include the name of the log file to which the log message is recorded. Log write instructions may be written in a source code by the developer of an application program or operating system in order to record the state of the application program or operating system at a point in time and to record events that occur while an operating system or application program is executing. For example, a developer may include log write instructions that record informative events including, but are not limited to, identifying startups, shutdowns. 1/O operations of applications or devices: errors identifying runtime deviations from normal behavior or unexpected conditions of applications or non-responsive devices; fatal events identifying severe conditions that cause premature termination; and warnings that indicate undesirable or unexpected behaviors that do not rise to the level of errors or fatal events. Problem-related log messages (i.e., log messages indicative of a problem) can be warning log messages, error log messages, and fatal log messages. Informative log messages are indicative of a normal or benign state of an event source.

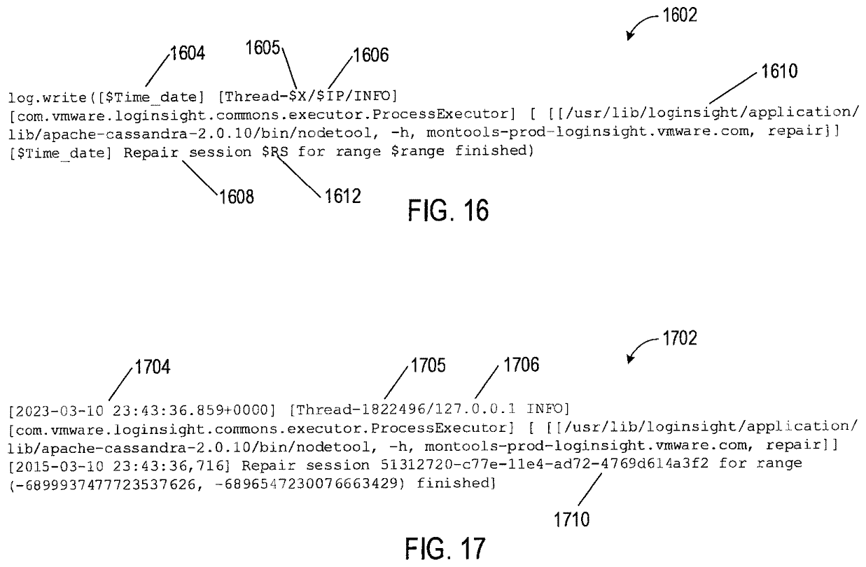

FIG. 16 shows an example of a log write instruction 1602. The log write instruction 1602 includes arguments identified with “$” that are filled at the time the log message is created. For example, the log write instruction 1602 includes a time-stamp argument 1604, a thread number argument 1606, and an internet protocol (“IP”) address argument 1608. The example log write instruction 1602 also includes text strings and natural-language words and phrases that identify the level of importance of the log message and type of event that triggered the log write instruction, such as “Repair session” 1608. The text strings between brackets “[ ]” represent file-system paths, such as path 1610. When the log write instruction 1602 is executed, parameters are assigned to the arguments and the text strings and natural-language words and phrases are stored as a log message in a log file.

FIG. 17 shows an example of a log message 1702 generated by the log write instruction 1602. The arguments of the log write instruction 1602 are assigned numerical parameters that are recorded in the log message 1702 at the time the log write instruction is executed. For example, the time stamp 1604, thread 1606, and IP address 1608 arguments of the log write instruction 1602 are assigned corresponding numerical parameters 1704. 1706, and 1708 in the log message 1702. The time stamp 1704 represents the date and time the log message is generated. The text strings and natural-language words and phrases of the log write instruction 1602 also appear unchanged in the log message 1702 and are used to identify the type of event (e.g., informative, warning, error, or fatal) that occurred during execution of the event source.

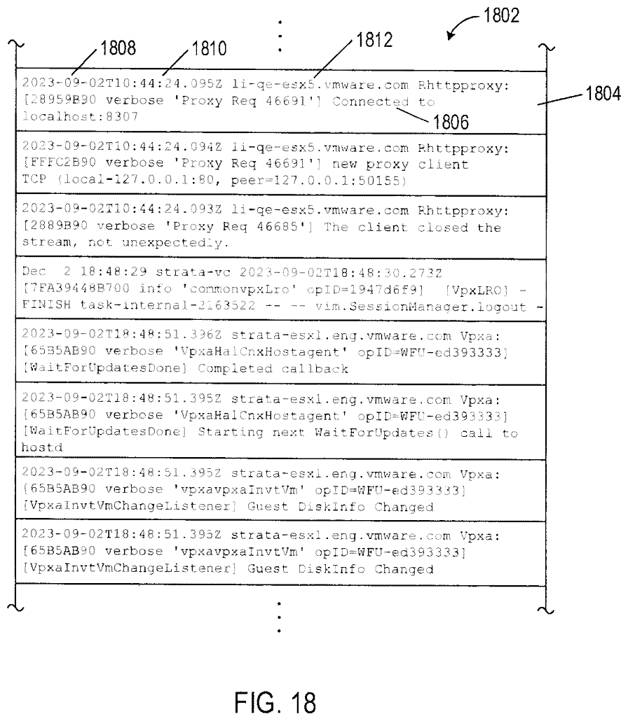

As log messages are received at the operations manager 1330 from various event sources, the log messages are stored in files in the order in which the log messages are received. FIG. 18 shows a small, eight-entry portion of a log file 1802. In FIG. 18, each rectangular cell, such as rectangular cell 1804, of the log file 1802 represents a single stored log message. For example, log message 1804 includes a short natural-language phrase 1806, date 1808 and time 1810 numerical parameters, and an alphanumeric parameter 1812 that identify a particular host computer server.

In one implementation, as streams of log messages are received by the operations manager 1330, the operations manager 1330 extracts parametric and non-parametric strings of characters called tokens from log messages using corresponding regular expressions that have been constructed to extract the tokens. A regular expression, also called “regex,” is a sequence of symbols that defines a search pattern in text data. Many regex symbols match letters and numbers. For example, the regex symbol “a” matches the letter “a,” but not the letter “b,” and the regex symbol “100” matches the number “100,” but not the number 101. The regex symbol “.” matches any character. For example, the regex symbol “.art” matches the words “dart,” “cart,” and “tart,” but does not match the words “art,” “hurt,” and “dark.” A regex followed by an asterisk “*” matches zero or more occurrences of the regex. A regex followed by a plus sign “+” matches one or more occurrences of a one-character regex. A regular expression followed by a questions mark “?” matches zero or one occurrence of a one-character regex. For example, the regex “a*b” matches b, ab, and aaab but does not match “baa.” The regex “a+b” matches ab and aaab but does not match b or baa. Other regex symbols include a “\d” that matches a digit in 0123456789, a “\s” matches a white space, and a “\b” matches a word boundary. A string of characters enclosed by square brackets, [ ], matches any one character in that string. A minus sign “−” within square brackets indicates a range of consecutive ASCII characters. For example, the regex [aeiou] matches any vowel, the regex [a-f] matches a letter in the letters abcdef, the regex [0-9] matches a 0123456789, the regex [._%+−] matches any one of the characters ._%+−. The regex [0-9a-f] matches a number in 0123456789 and a single letter in abcdef. For example, [0-9a-f] matches a6, i5, and u2 but does not match ex. 9v, or %6. Regular expressions separated a vertical bar “|” represent an alternative to match the regex on either side of the bar. For example, the regular expression Get|GetValue|Set|SetValue matches any one of the words: Get, GetValue, Set, or SetValue. The braces “{ }” following square brackets may be used to match more than one character enclosed by the square brackets. For example, the regex [0-9]{2} matches two-digit numbers, such as 14 and 73 but not 043 and 4, and the regex [0-9]{1-2}matches any number between 0 and 99, such as 3 and 58 but not 349.

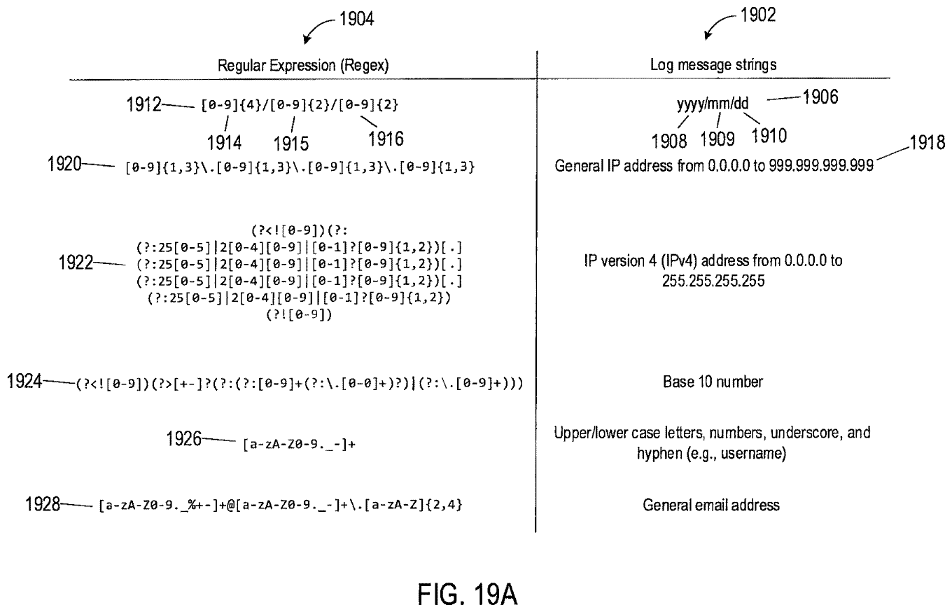

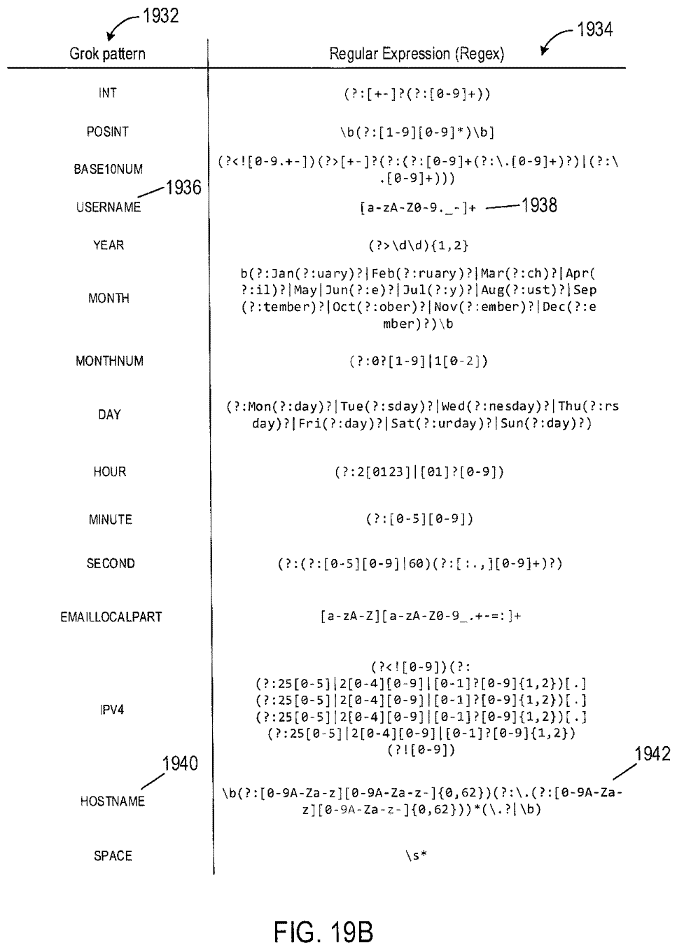

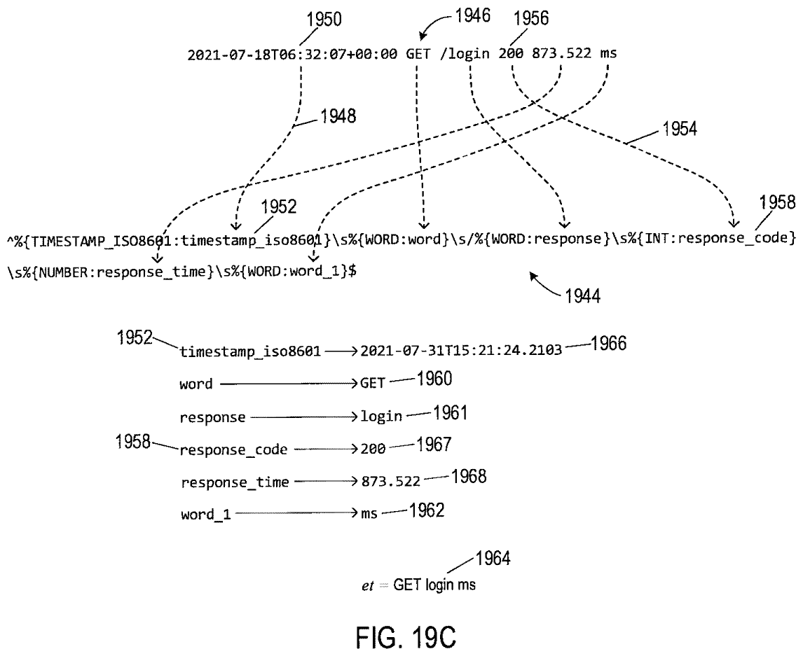

Simple regular expressions are combined to form larger regular expressions that match character strings of log messages and are used to extract the character strings from the log messages. FIG. 19A shows a table of examples of regular expressions designed to match particular character strings of log messages. Column 1902 lists six different types of strings that may be found in log messages. Column 1904 lists six regular expressions that match the character strings listed in column 1902. For example, entry 1906 of column 1902 represents a format for a date used in the time stamp of many types of log messages. The date is represented with a four-digit year 1908, a two-digit month 1909, and a two-digit day 1910 separated by slashes. The regex 1912 includes regular expressions 1914-1916 separated by slashes. The regular expressions 1914-1916 match the characters used to represent the year 1908, month 1909, and day 1910. Entry 1918 of column 1902 represents a general format for internet protocol (“IP”) addresses. A typical general IP address comprises four numbers. Each number ranges from 0 to 999 and each pair of numbers is separated by a period, such as 27.0.15.123. Regex 1920 in column 1904 matches a general IP address. The regex [0-9]{1-3} matches a number between 0 and 999. The backslash “\” before each period indicates the period is part of the IP address and is different from the regex symbol “.” used to represent any character. Regex 1922 matches any IPv4 address. Regex 1924 matches any base-10 number. Regex 1926 matches one or more occurrences of a lower-case letter, an upper-case letter, a number between 0 and 9, a period, an underscore, and a hyphen in a character string. Regex 1928 matches email addresses. Regex 1928 includes the regex 1926 after the ampersand symbol. Regular expressions are used to extract non-parametric tokens that combine to form the event type of the log message.

In another implementation, the operations manager 1330 extracts tokens from log messages using corresponding Grok expressions that have been constructed to extract the tokens. Grok is a regular expression dialect that supports reusable aliased expressions. Grok patterns are predefined symbolic representations of regular expressions that reduce the complexity of constructing regular expressions. Grok patterns are categorized as either primary Grok patterns or composite Grok patterns that are formed from primary Grok patterns. A Grok pattern is called and executed using the notation Grok syntax %{SYNTAX}.

FIG. 19B shows a table of examples of primary Grok patterns and corresponding regular expressions. Column 1932 contains a list of primary Grok patterns. Column 1934 contains a list of regular expressions represented by the Grok patterns in column 1932. For example, the Grok pattern “USERNAME” 1936 represents the regex 1938 that matches one or more occurrences of a lower-case letter, an upper-case letter, a number between 0 and 9, a period, an underscore, and a hyphen in a character string. Grok pattern “HOSTNAME” 1940 represents the regex 1942 that matches a hostname. A hostname comprises a sequence of labels that are concatenated with periods. Note that the list of primary Grok patterns shown in FIG. 19B is not an exhaustive list of primary Grok patterns.

Grok patterns may be used to map specific character strings into dedicated variable identifiers. The syntax for using a Grok pattern to map a character string to a variable identifier is given by:

%{GROK_PATTERN:variable_name}
where
   GROK_PATTERN represents a primary or a composite Grok pattern; and
   variable_name is a variable identifier assigned to a character string in text data that matches the GROK_PATTERN.
      A Grok expression is a parsing expression that is constructed from Grok patterns that match characters strings in text data and are used to parse character strings of a log message. Consider, for example, the following simple example segment of a log message:

34.5.243.1 GET index.html 14763 0.064

A Grok expression that may be used to parse the example segment is given by:

\hat{ }%{IP:ip_address}\s %{WORD:word}\s %{URIPATHPARAM:request}\s

%{INT:bytes}\s%{NUMBER:duration}$

The hat symbol “\hat{ }” identifies the beginning of a Grok expression. The dollar sign symbol “$” identifies the end of a Grok expression. The symbol “\s” matches spaces between character strings in the example segment. The Grok expression parses the example segment by assigning the character strings of the log message to the variable identifiers of the Grok expression as follows:
ip_address: 34.5.243.1
word: GET
request: index.html
bytes: 14763
duration: 0.064

Different types of regular expressions and Grok expressions are constructed to match token patterns of log messages and extract non-parametric tokens from the log messages. Numerous log messages may have different parametric tokens but the same set of non-parametric tokens. The non-parametric tokens extracted from a log message describe the type of event, or event type, recorded in the log message. The event type of a log message is denoted by eta, where subscript n is an index that distinguishes the different event types of the log messages. Event types can be extracted from the log messages using Regex or Grok expressions.

FIG. 19C shows an example of a Grok expression 1944 used to extract tokens from a log message 1946. Dashed directional arrows represent parsing the log message 1946 such that tokens that correspond to Grok patterns of the Grok expression 1944 are assigned to corresponding variable identifiers. For example, dashed directional arrow 1948 represents assigning the time stamp 2021-07-18T06:32:07+00:00 1950 to the variable identifier timestamp_iso86011 952 and dashed directional arrow 954 represents assigning HTTP response code 200 1956 to the variable identifier response_code 1958. FIG. 19C shows assignments of tokens of the log message 1946 to variable identifiers of the Grok expression 1944. The combination of non-parametric tokens 1960-1962 identify the event type 1964 of the log message 1946. Parametric tokens 1966-1968 may change for different log messages with the same event type 1964.

Computer-Implemented Methods and Systems for Automated Application Discovery from Log Messages

The operations manager 1330 executes application discovery (“AD”) on event types of log messages generated by event sources of various objects executing in cloud environment. The event sources are monitored by the operations manager 1330 over a time period. The time periods can be a day, two days, five days, a week or longer. The operations manager 1330 partitions the time period into subintervals, uses Regex or Grok expressions to extract event types from log messages with time stamps in each of the subintervals, and determines counts of event types in subintervals. For example, the subintervals of the time period may be one-hour subintervals, 2-hour subintervals, 4-hour subintervals, or 8-hour subintervals. The counts are converted into relative frequencies or probabilities of event types for each of the subintervals. The operations manager 1330 computes a probability distribution, Pₜ, where l=1,,2, . . . , L and L is the number of subintervals of the time period. The probabilities of the subintervals are determined based on the total number of different event types extracted from the log messages produced in the time period, which introduces sparsity into each of the probability distributions.

Let N be the total number of possible event types that can be extracted from log messages generated by event sources in the time period. The operations manager 1330 computes the number of times, or count, of each event type that appeared in a subinterval. Let c_{l,n} denote an event type counter of the number of times the event type etₙ occurred in the l-th subinterval, where n=1, . . . , N. The operations manager 1330 normalizes the count of each event type to obtain a corresponding event type probability given by:

$${p}_{l , n} = \frac{{c}_{l , n}}{{K}_{l}} \qquad ( 1 )$$

where Kₗ is the number of log messages generated in the l-th time interval.

The operations manager 1330 forms a probability distribution of the event types occurring in the l-th subinterval is given by:

$${P}_{l} = ( {p}_{l 1} , … , {p}_{l , n} , … , {p}_{l , N} ) \qquad ( 2 )$$

The probability distribution contains the probabilities of the N event types associated with the event sources whether or not all N event types generated by the event sources occurred the l-th subinterval. In these cases, p_{l,n}=0 (i.e., c_{l,n}=0). In other words, the probability distribution is like a fingerprint of the event types that occurred in each subinterval.

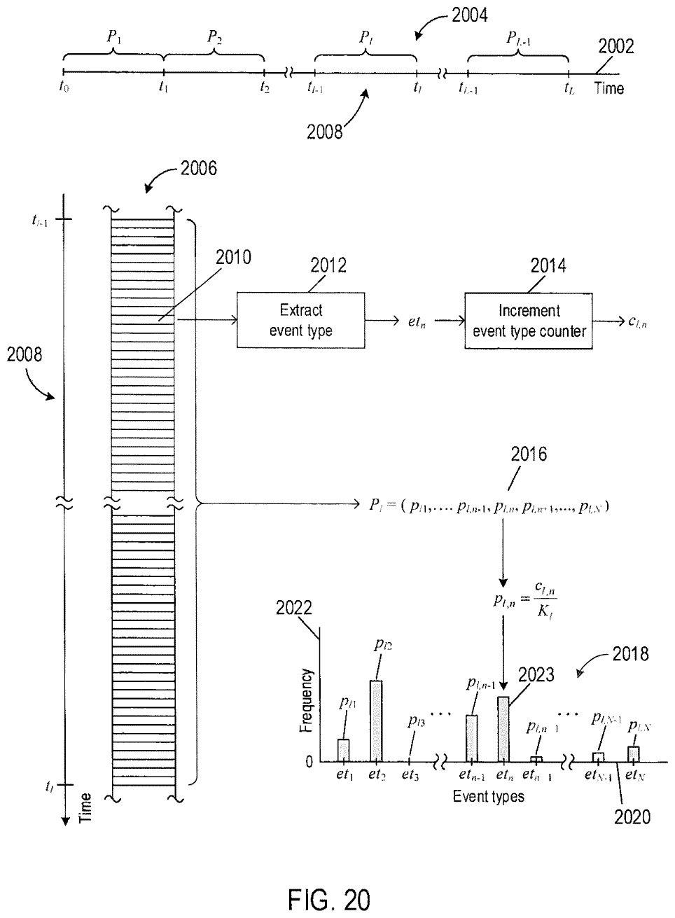

FIG. 20 shows construction of example probability distribution from log messages of an object produced in a subinterval of a time period. FIG. 20 shows a time axis 2002 with a time period [t_{D}, t_{L}] 2304, where t₀ denotes the start time and t_{L} denotes the end time of the time period. FIG. 20 also shows series of log message 2006 that contains log messages generated by event sources with time stamps in the l-th subinterval [tₗ₋₁, tₗ] 2008. Each log message is represented by a rectangle. For example, rectangle 2010 represents a log message with a time stamp in the subinterval 2008. The operations manager 1330 extracts event types using Regex or Grok expressions as described above with reference to FIGS. 19A-19C. In block 2012, an event type, etₙ, is extracted from the log message 2010. In block 2014, the operations manager 1330 increments a count, c_{l,n}, of the event type etₙ. The operations manager 1330 normalizes the counts to obtain corresponding probabilities and forms a probability distribution from the probabilities of the event types in the subintervals. Probability distribution 2016 represents the probabilities of the event types occurring in the subinterval 2008. FIG. 20 shows an example plot 2018 of the probabilities of the probability distribution 2016. The horizontal axis 2020 represents the range of all possible event types generated in the time period. The vertical axis 2022 represents the range of probabilities. Bars represent the probabilities of the event types. For example, bar 2023 represents the probability, p_{l,n} of the event type etₙ occurring in the subinterval 2008. The probability distribution 2016 includes zero probabilities that correspond to event types that did not occur in the subinterval 2008. For example, the probability, pₗ₃, of the event type et₃ is zero because no log messages with the event type et₃ were generated in the subinterval 2008 but were generated in at least one other subinterval of the time period 2004.

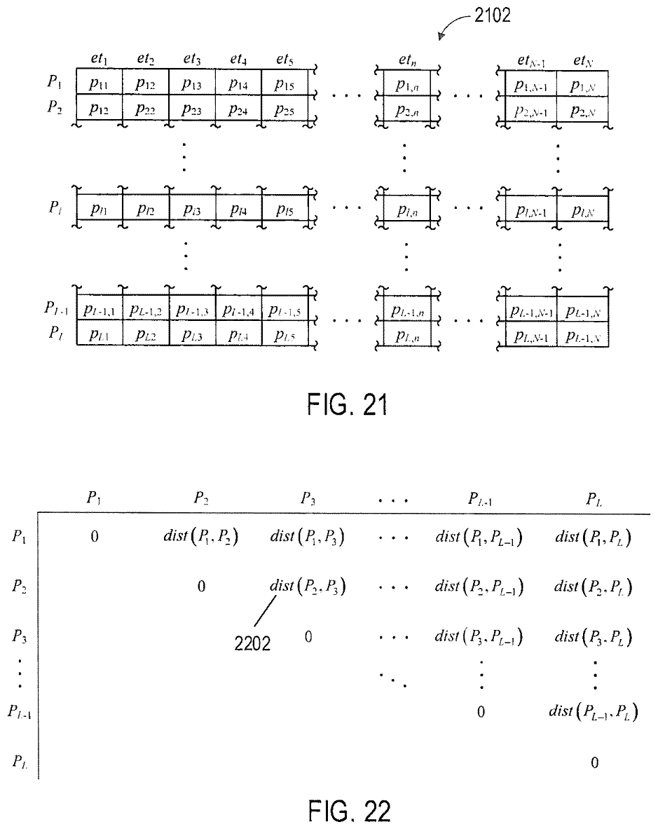

The operations manager 1330 computes a probability distribution of event types as described above for each of the subintervals [tₗ₋₁, tₗ], where l=1, . . . , L, of the time period 2004. The operations manager 1330 forms a data frame 2102 from the probability distributions as shown in FIG. 21. Each row of the data frame 2102 contains the probabilities of the N different event types for one of the L probability distributions. Each column of the data frame 2102 contains the probabilities of one of the event types for each of the probability distributions.

The operations manager 1330 performs hierarchical clustering of the probabilities in the data frame 2102. The operations management server 132 computes the Jaccard distance between each pair of probability distributions:

$$dist ( {P}_{i} , {P}_{j} ) = 1 - J ( {P}_{i} , {P}_{j} ) \qquad ( 3 )$$

where
   i,J=1, . . . , L; and
   the Jaccard coefficient is given by

$$J ( {P}_{i} , {P}_{j} ) = \frac{\vert {P}_{i} ⋂ {P}_{j} \vert}{\vert {P}_{i} \vert + \vert {P}_{j} \vert}$$

The Jaccard distance is a measure of the similarity between the probability distributions Pᵢ and Pⱼ. The quantity |Pᵢ| is a count of the number probabilities in the probability distribution Pₗ that satisfy the condition p_{i,n}≥Thₑₜ, where Thₑₜ is the similarity threshold (e.g., Thₑₜ=0.001 or 0.005). The quantity |Pᵢ∩Pⱼ| is a count of the number probabilities in the probability distributions Pᵢ and Pⱼ that satisfy both of the conditions p_{i,n}≥Thₑₜ and p_{j,n}≥Thₑₜ. The Jaccard distance 0≤dist(Pᵢ, Pⱼ)≤1, where a dist(Pᵢ, Pⱼ)=0 means the probability distributions Pᵢ and Pⱼ are similar and contain the same probabilities that satisfy the condition p_{i,n}≥Thₑₜ, and a dist(Pᵢ, Pⱼ)=1 means the probability distributions Pᵢ and Pⱼ are dissimilar and do not have any of the same probabilities that satisfy the condition p_{i,n}≥Thₑₜ.

FIG. 22 shows an example distance matrix of distances calculated for each pair of probability distributions computed as described above with reference to Equation (3). For example, distance matrix element dist(P₂, P₃) 2202 represents the distance between probability distributions P₂ and P₃. Note that because dist(Pᵢ, Pⱼ)=dist(Pⱼ, Pᵢ), the distance matrix is a symmetric matrix with only the upper diagonal matrix elements represented. The diagonal elements are equal to zero (i.e., dist(Pᵢ, Pᵢ)=0).

After distances have been calculated for each pair of event distributions, the operations manager 1330 performs hierarchical clustering to identify clusters of probability distributions. Hierarchical clustering is an unsupervised machine learning technique for identifying clusters of similar probability distributions. Hierarchical clustering is applied to the distances in the distance matrix using agglomerative clustering in which each probability distribution begins in a single element cluster and pairs of clusters are merged based on similarity and all probability distributions belong to the same cluster represented by a tree called a dendrogram. In other words, the dendrogram is a branching tree diagram that represents a hierarchy of relationships between probability distributions. The resulting dendrogram may then be used to identify clusters of objects.

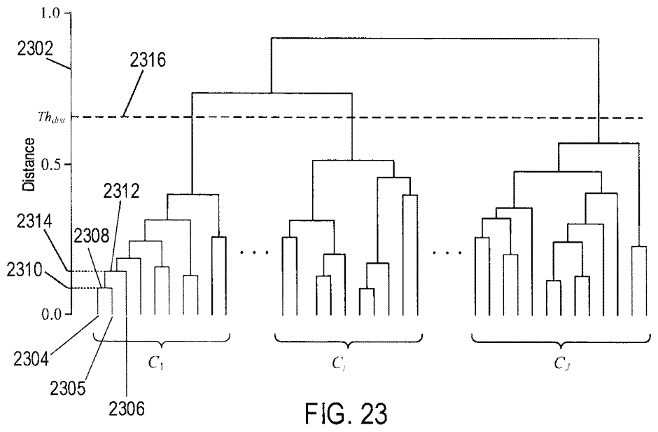

FIG. 23 shows an example dendrogram constructed from Jaccard distances between pairs of probability distributions. Vertical axis 2302 represents a range of Jaccard distances between 0 and 1. The dendrogram is a branching tree diagram in which the ends of the dendrogram, called “leaves.” represent the probability distributions. For example, leaves 2304-2306 represent three different probability distributions. The branch points represent the Jaccard distances between probability distributions. For example, branch point 2308 corresponds to the distance 2310 between the probability distributions 2304 and 2305. Branch point 2312 corresponds to the distance 2314 between the probability distributions 2305 and 2306. The height of a branch point represents the distance, or degree of similarity, between two probability distributions. In the example of FIG. 23, the smaller the value of a branch point, the closer the probability distributions are to each other in the N-dimensional space. For example, because the branch point 2308 is closer to zero than the branch point 2312, the probability distributions 2304 and 2305 are more similar to one another than the probability distributions 2306 is to either of the distributions 2304 and 2305.

A distance threshold. Th_{dist}, is used to separate or cut the tree of the hierarchical cluster into smaller trees with probability distributions that correspond to clusters. The distance threshold is determined based on the Silhouette scoring or Calinski-Harabasz scoring as described below. Probability distributions connected by branch points (i.e., Jaccard distances) that are greater than the distance threshold are separated or cut into clusters. For example, in FIG. 23, dashed line 2316 represents a distance threshold. Probability distributions connected by branch points (i.e., Jaccard distances) that are greater than the threshold Th_{dist} are separated into clusters. In other words, probability distributions with Jaccard distances that are less than the threshold 2316 form clusters. For example, C₁ is a cluster of probability distributions connected by branch points that are less than the threshold Th_{dist}, Cⱼ is another cluster of probability distributions connected by branch points that are less than the threshold Th_{dist}, and Cⱼ is a cluster of probability distributions connected by branch points that are less than the threshold Th_{dist}.

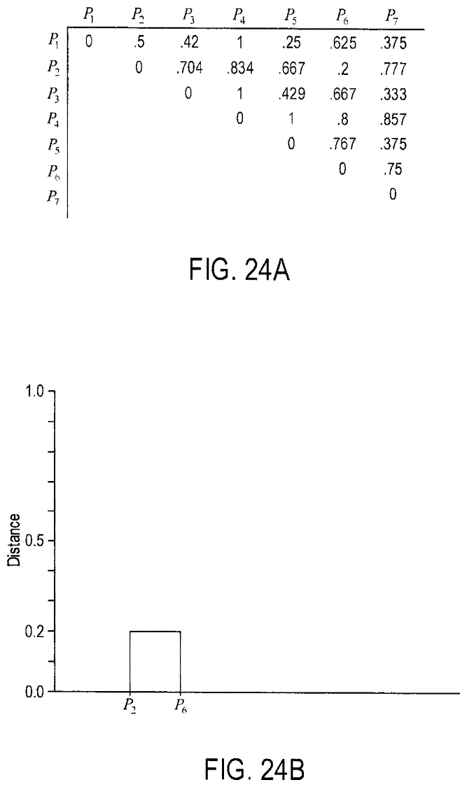

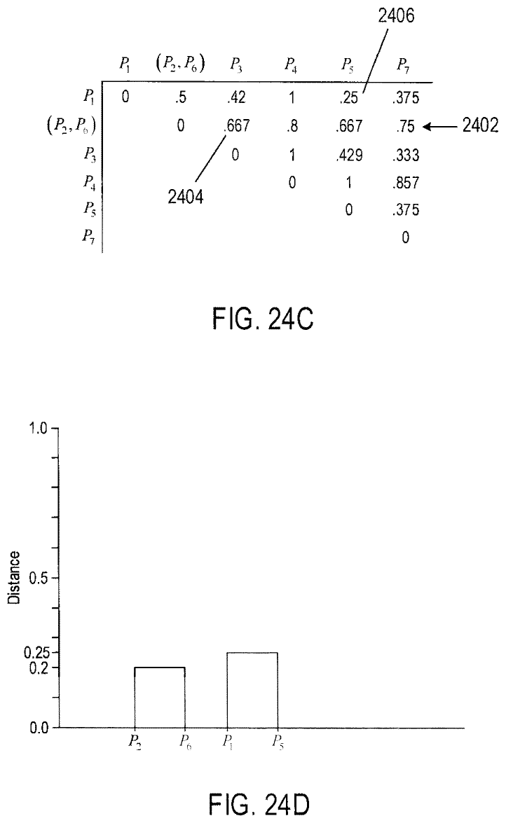

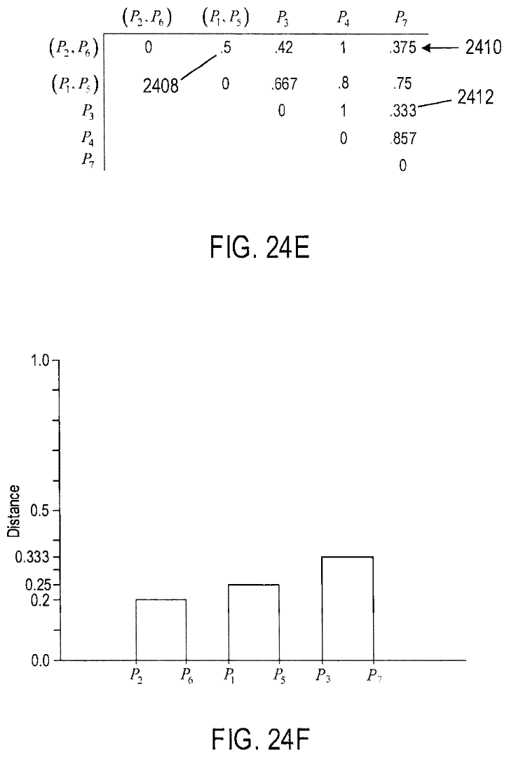

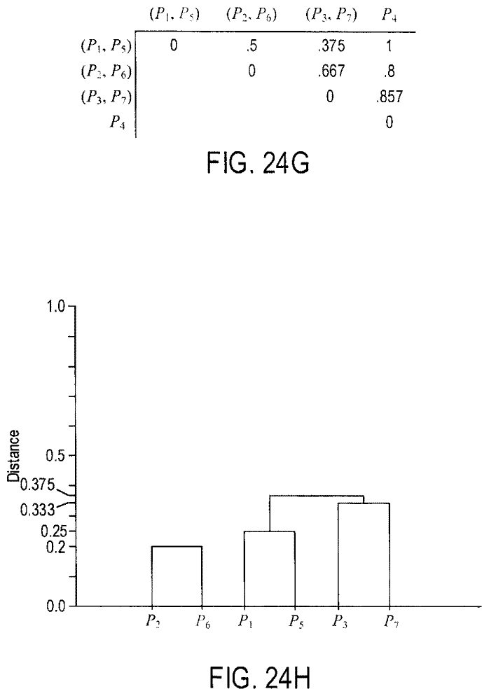

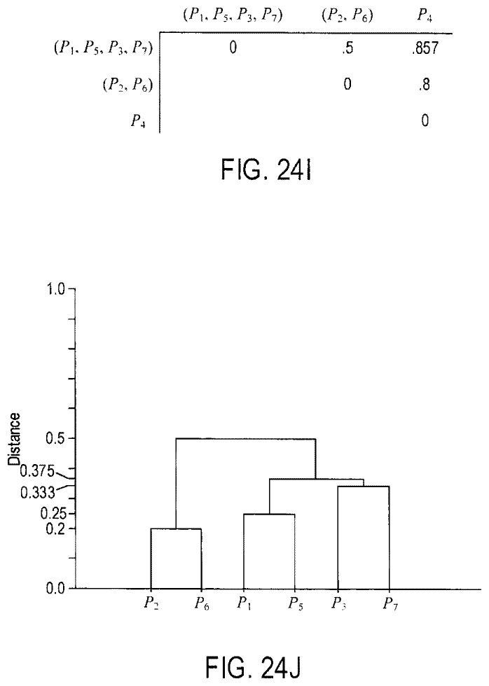

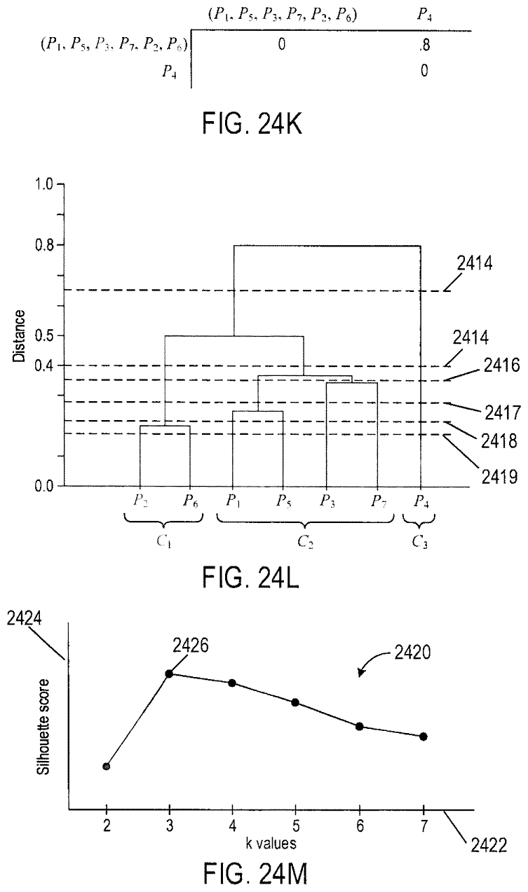

FIGS. 24A-24M show an example of hierarchical clustering applied to seven probability distributions using a minimum linkage (i.e., minimum distance) criterion. The probability distributions are denoted by P₁, P₂, P₃, P₄, P₅, P₆, and P₇. FIG. 24A shows an example distance matrix calculated for pairs of the seven probability distributions. An initial step in hierarchical clustering is identifying a pair of probability distributions with the shortest distance. In the example of FIG. 24A, probability distributions P₂ and P₆ have the smallest distance of 0.2. In FIG. 24B, probability distributions P₂ and P₆ are the first two leaves added to the dendrogram and are linked at the distance 0.2. After the pair of probability distributions have been linked, a reduced distance matrix is formed in FIG. 24C. The probability distributions P₂ and P₆ are removed from the distance matrix in FIG. 24C and linked probability distributions (P₂, P₆) is introduced. The minimum linkage criterion is used to determine the distances between the linked probability distributions (P₂,P₆) and the other probability distributions in the row 2002. The distance at each element of the row 2402 is the minimum of the distance of the linked probability distributions (P₂, P₆) with each of the remaining probability distributions. For example, dist(P₂, P₃) is 0.704 and dist(P₆, P₃) is 0.667 obtained from corresponding matrix elements in FIG. 24A. The min(dist(P₂, P₃), dist(P₆, P₃)) is 0.667. Therefore, the distance between the linked probability distribution (P₂, P₆) and the probability distribution P₃ is 0.667 as represented by matrix element 2404. The remaining elements in the row 2402 in FIG. 24C are determined in the same manner. The smallest distance in the distance matrix of FIG. 24C is 0.25 2406 for probability distributions P₁ and P₅. In FIG. 24D, the probability distributions P₁ and P₅ are two more leaves added to the dendrogram linked at the distance 0.25. The rows associated with the probability distributions P₁ and P₅ are removed from the distance matrix shown in FIG. 24E and the minimum linkage criterion is repeated for the linked probability distributions (P₁, P₅) to obtain the distances in the row 2408 in FIG. 24E. For example, in FIG. 24C, the distance between (P₂,P₆) and P₁ is 0.5 and the distance between (P₂, P₆) and P₅ is 0.667. The minimum of the two distances is 0.5 as represented by the matrix element 2408 in FIG. 24E. The remaining elements in the row 2410 in FIG. 24E are determined in the same manner. The smallest distance in the distance matrix of FIG. 24E is 0.333 2412. In FIG. 24F, the probability distributions P₃ and P₇ are two more leaves added to the dendrogram and are linked at the distance 0.333. FIGS. 24G-24L show distance matrices and corresponding dendrograms constructed using the minimum linkage criterion at each step. FIG. 24L shows the final dendrogram.

In FIG. 24L, dashed lines 2414-2419 represent six thresholds for partitioning the probability distributions into k clusters, where k is the number of clusters. For example, threshold 2414 partitions the probability distributions into k=2 clusters with probability distributions P₂, P₆, P₁, P₅, P₃, and P₇ in one cluster and P₄ in the other; and threshold 2415 partitions the probability distributions into k=3 clusters with probability distributions P₂ and P₆ in one cluster, probability distributions P₁, P₅, P₃, and P₇ in a second cluster, and P₄ in a third cluster. In one implementation, the operations manager 1330 uses Silhouette scoring to determine the optimal number of clusters (i.e., optimal k value).

Silhouette scores are computed for each value of k as a measure of how similar a probability distribution is to other probability distributions in the same cluster. For each k, a threshold is used to partition the probability distributions into k clusters. For example, in FIG. 24L, for k=2, the threshold 2414 may be used to partition the probability distributions into two clusters. A Silhouette score is computed for each of the probability distributions in the same cluster. For each probability distribution Pᵢ in a cluster Cₗ an average distance between Pᵢ and all the other probability distributions in the cluster Cₗ are computed as follows:

$$a ( {P}_{i} ) = \frac{1}{\vert {C}_{I} \vert - 1} {\sum }_{{P}_{j} ∈ {C}_{I} , i \neq j} d ( {P}_{i} , {P}_{j} ) \qquad ( 4 )$$

where |Cₗ| is the number of probability distributions in the cluster Cₗ.
   The parameter a(Pᵢ) is a measure of how close the probability distribution Pᵢ is to other probability distributions in the cluster Cₗ. The smaller the parameter a(Pᵢ), the better the assignment to the cluster Cₗ. For each probability distribution Pᵢ in a cluster Cₗ a mean dissimilarity of the probability distribution Pᵢ to other probability distributions in each of other clusters is computed as follows:

$$b ( {P}_{i} ) = {min}_{J \neq I} \frac{1}{\vert {C}_{I} \vert} {\sum }_{{P}_{j} ∈ {C}_{J}} d ( {P}_{i} , {P}_{j} ) \qquad ( 5 )$$

The mean dissimilarity b(Pᵢ) is the average distance from the probability distribution Pᵢ to the other clusters that the probability distribution Pᵢ does not belong to. The cluster with the smallest mean dissimilarity of the probability distribution Pᵢ is the “neighboring cluster” that is the next best fit cluster for of the probability distribution Pᵢ. The Silhouette value of the probability distribution Pᵢ is given by

$$s ( {P}_{i} ) = \frac{b ( {P}_{i} ) - a ( {P}_{i} )}{max \{ a ( {P}_{i} ) , b ( {P}_{i} ) \}} \qquad ( 6 )$$

for |Cₗ|>1, and s(Pᵢ)=0 for |Cₗ|=1. The Silhouette value is −1≤s(Pᵢ)≤1. The Silhouette score is an average of the Silhouette values of the full set of probability distributions:

$$S ( k ) = \frac{1}{N} {\sum }_{i = 1}^{N} s ( {P}_{i} ) \qquad ( 7 )$$

The Silhouette score is a measure of how appropriately the probability distributions have been clustered for k clusters. The Silhouette score computed for each value of k are compared. The number of clusters k typically corresponds to the largest of the Silhouette scores that produces the fewest clusters.

FIG. 24M shows an example plot of Silhouette scores 2420 for k=2, . . . , 7. Horizontal axis 2422 represents the k values. Vertical axis 2424 represents the range of Silhouette scores. Points represent example Silhouette scores for clusters of probability distributions in FIG. 24L. In this example. Silhouette score 2426 is the largest Silhouette score that produces the fewest clusters, indicating the threshold 2415 should be used to partition the probability distributions into three clusters with the probability distributions P₂ and P₆ forming a cluster C₁, the probability distributions P₁, P₅, P₃, and P₇ forming a cluster C₂, and the probability distribution P₄ forming a cluster C₃.

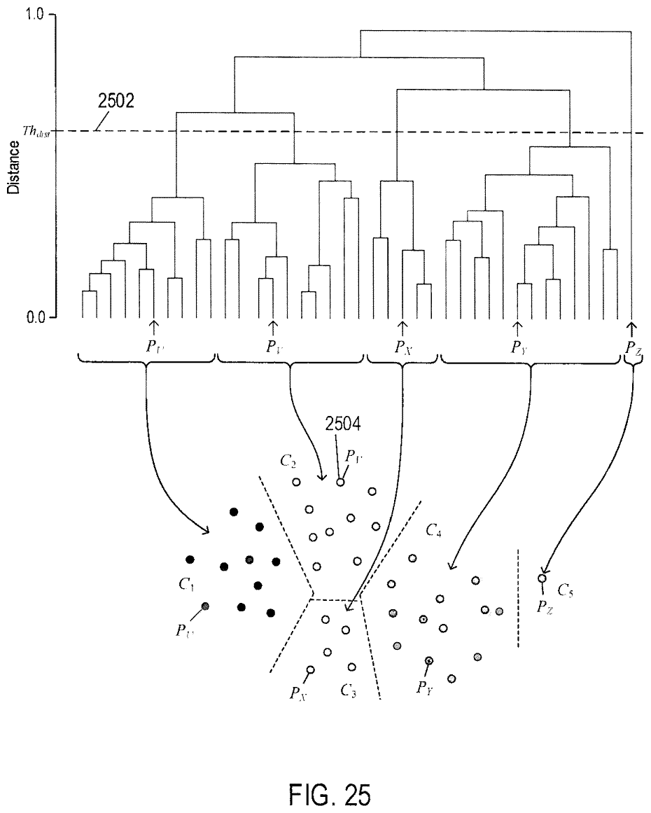

Hierarchical clustering gives clusters of the probability distributions that correspond to points in an N-dimensional space. FIG. 25 shows an example dendrogram with clusters of probability distributions. Dashed line 2502 represents a distance threshold Th_{dist} that creates fives clusters of probability distributions denoted by C₁, C₂, C₃, C₄, and C₅. For example, cluster C₁ includes probability distribution P_{V}, cluster C₂ includes probability distribution P_{V}, cluster C₃ includes probability distribution P_{X}, cluster C₄ includes probability distribution P_{Y}, and cluster C₅ comprises only one probability distribution P_{Z}. The probability distributions correspond to points in an N-dimensional space. For the sake of illustration, FIG. 25 shows an example of an N-dimensional space represented in two-dimensions with differently shaded points that correspond to probability distributions in the clusters C₁, C₂, C₃, C₄, and C₅. For example, unshaded points represent probability distributions in the cluster C₂, such as unshaded point 2504 representing a probability distribution P_{V}.

Hierarchical clustering gives different clusters that correspond to different applications. For example, the clusters C₁, C₂, C₃, C₄, and C₅ in FIG. 25 correspond to five different applications executing in the cloud infrastructure. The clusters identified with hierarchical clustering may not distinguish between separate instances of the same application subject to workload patterns. For example, the clusters of probability distributions identified with hierarchical clustering may not distinguish application instances that are subject to different workload patterns. To distinguish application instances subject to different workload patterns within the clusters of probability distributions, the operations manager 1330 uses t-distributed stochastic neighbor embedding (“t-SNE”) to project the probability distributions in the data frame into a lower dimensional space, such as a two-dimensional or three-dimensional space. The resulting projection is a two- or three-dimensional map of the applications with each point in the map corresponding to one of the probability distributions. The operations manager 1330 applies density-based clusters on neighborhoods of the points in the map of the applications to identify clusters of points that correspond to probability distributions in the lower dimensional space.

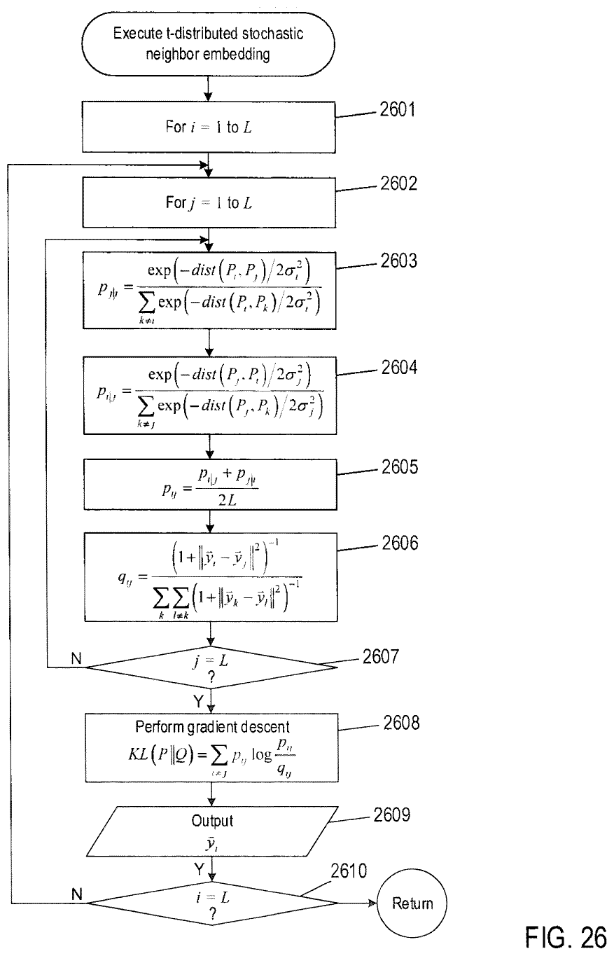

FIG. 26 is a flow diagram of a method for performing t-SNE for each of the L probability distributions in the data frame 2102. A loop beginning with block 2601 repeats the computational operations represented by blocks 2602-2610 for each of the probability distributions. A loop beginning with block 2602 repeats the computational operations represented by blocks 2603-2606 for each of the probability distributions. In block 2603, a conditional probability p_{i|j} is computed as represented in block 2603. In block 2604, a conditional probability p_{j|i} is computed as represented in block 2604. The conditional probabilities pₜᵢⱼ and p_{j|i} depend on the Jaccard distance given by Equation (3). In block 2605, the similarity probability pᵢⱼ is computed from the conditional probabilities computed in the blocks 2603 and 2604. The t-SNE learns a map of applications with points [symbol] , . . . , [symbol] , where [symbol] ∈ [symbol] (or [symbol] ∈ [symbol] ), that correspond to the probability distributions P₁, . . . , P_{L}. Similarities between any two points [symbol] and [symbol] in the map of applications as represented in block 2606. In decision block 2607, when j=L control flows to block 2608. Otherwise, the computational operations represented by blocks 2603-2606 are repeated. In block 2608, gradient descent is performed on the Kullback-Leibler divergence of the probability {pᵢⱼ}ⱼ₌₁^{L} and {qᵢⱼ}ⱼ₌₁^{L} to output the point [symbol] 2609 of the map of applications. In decision block 2610, the operations represented by blocks 2602-2609 are repeated until i=L.

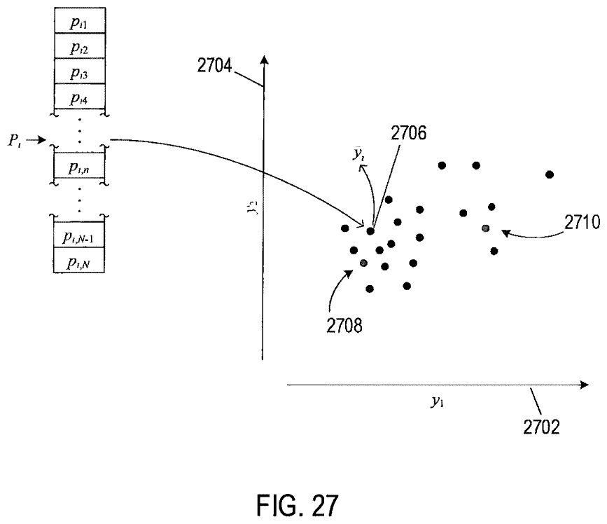

FIG. 27 shows an example plot of points in a map of applications obtained from performing t-SNE on a set of probability distributions. The points are denoted by [symbol] =(yᵢ₁, yᵢ₂). Horizontal axis 2702 represents a range of values for the first coordinate y₁. Vertical axis 1804 represents a range of values for the second coordinate y₂. Solid points represent points in the map of applications. For example, t-SNE maps the probability distribution Pᵢ to the point [symbol] 2706 in two-dimensional space. In other words, each point in the two-dimensional map of applications represents a corresponding probability distribution. FIG. 27 also shows examples of points that form clusters 2708 and 2710 in the map of applications.

Clusters of points in a map of applications correspond to different applications and may reveal instances of the applications that correspond to different workloads. The number of clusters corresponds to the number of applications. The more clusters the greater the diversity of applications. The map of applications can be used to identify applications based on the proximity of points in the map of applications. The operations manager 1330 performs hierarchical density-based spatial clustering (“HDBSCAN”) for different values of the number of clusters (i.e., different k values) and calculates corresponding Silhouette scores as described above with reference to Equations (4)-(7) to identify clusters of points in a map of the applications.

HDBSCAN is based on neighborhoods of the points in the map of applications. The neighborhood of a point [symbol] is defined by

$${N}_{ϵ} ( {\vec{y}}_{l} ) \{ {\vec{y}}_{i} ∈ C \vert {dist}_{E} ( {\vec{y}}_{l} , {\vec{y}}_{i} ) \leq ϵ \} \qquad ( 8 )$$

where dist_{E}( [symbol] , [symbol] ) represent the Euclidean distance.
   In two dimensions, the Euclidean distance is given by dist_{E} ( [symbol] , [symbol] =\sqrt{(yₗ₁−yᵢ₁)²+(yₗ₂−yᵢ₂)²}. The number of points in a neighborhood of a point [symbol] is given by |N_{∈}( [symbol] )|, where [⋅] denotes cardinality of a set. HDBSCAN performs density-based spatial clustering over varying epsilon values and integrates the result to find a clustering that gives the best stability over epsilon. This allows HDBSCAN to find clusters of varying densities and be more robust to parameter selection.

A point is identified as a core point of a cluster of point, an edge point of a cluster of points, or a noise point based on the number of points that lie within the neighborhood of the point. Let MinPts represent a user selected minimum number of points for a core point. A point [symbol] is a core point of a cluster of points when |N_{∈}( [symbol] )|≥MinPts. A point [symbol] is border point of a cluster of points when MinPts>|N_{∈ (} [symbol] _{)|>}1 and contain at least one core point in addition to the point [symbol] . A point Xₘ is noise when |N_{∈(} [symbol] _{)|=}1 (i.e., when the neighborhood contains only the point [symbol] .

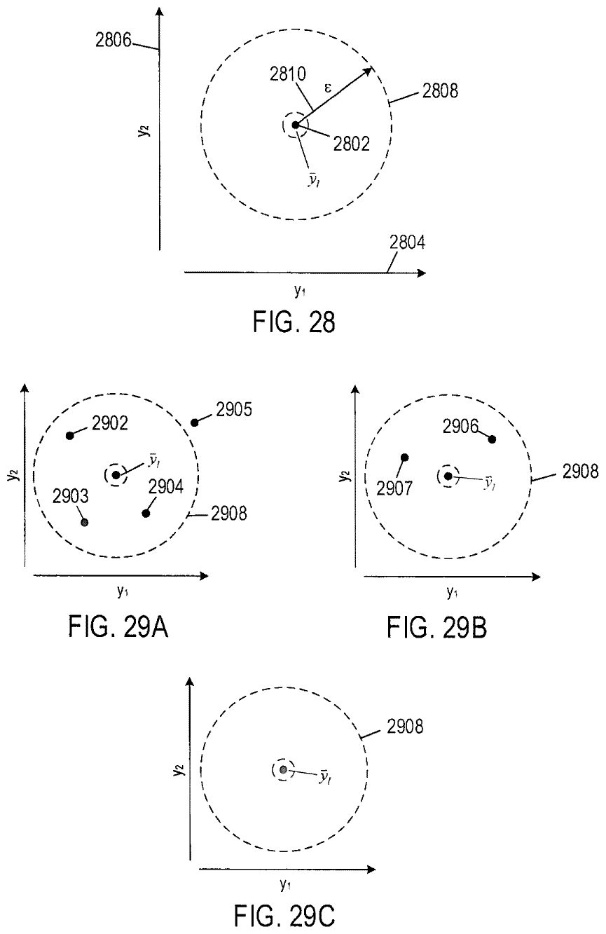

FIG. 28 shows an example of a neighborhood of the point [symbol] denoted by the point 2802. Horizontal axis 2804 and vertical axis 2806 represent axes in a two-dimensional space. The two-dimensional neighborhood of the point, N_{∈}( [symbol] ), is represented by a dashed circle 2808 of radius 2810 centered on the point [symbol] 802. A point [symbol] is an element of the neighborhood N_{∈(} [symbol] _{) if dist}_{E}( [symbol] , [symbol] )≤∈.

FIGS. 29A-29C show examples of the point [symbol] as a core point, a border point, and noise, respectively. In this example, the minimum number of points for a core point is set to 3 (i.e., MinPts=3). In FIG. 29A, points 2902-2905 represent points that are near the point [symbol] in the two-dimensional space. The point [symbol] is a core point because the three points 2902-2904 lie within the neighborhood 2908. As a result, the neighborhood 1908 contains 3 points, which is equal to MinPts. In FIG. 29B, the point [symbol] is a border point because the neighborhood 2908 contains the two points 2906 and 2907. In FIG. 29C, the point [symbol] is noise because the neighborhood 2908 contains only the single point [symbol] .

A point [symbol] is directly density-reachable from another point [symbol] if 1) [symbol] ∈ N_{∈}( [symbol] ) and [symbol] is a core point (i.e., |N_{∈}( [symbol] )|≥MinPts. In FIG. 29A, the point 2902 is directly density-reachable from the point [symbol] because the point 2902 lies within the neighborhood 2908 and the neighborhood contains three points.

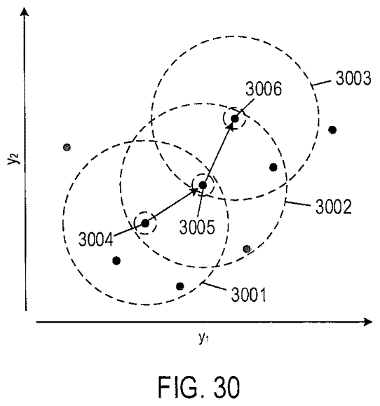

A point [symbol] is density reachable from a point [symbol] if there is a chain of points [symbol] , . . . , [symbol] , such that [symbol] is directly density-reachable from [symbol] for m=1, . . . , n. FIG. 30 shows an example of a density reachable point. Neighborhoods 3001-3003 are centered at points 3004-3006, respectively. Point 3006 is density reachable from the point 3004 because there is an intermediate point 3005 that is directly density-reachable from the point 3004 and the point 3006 is directly density-reachable from the point 3005.

Given MinPts and the radius ϵ, a cluster of points can be discovered by first arbitrarily selecting a core point as a seed and retrieving all points that are density reachable from the seed obtaining the cluster containing the seed. In other words, consider an arbitrarily selected core point. Then the set of points that are density reachable from the core point is a cluster of points.

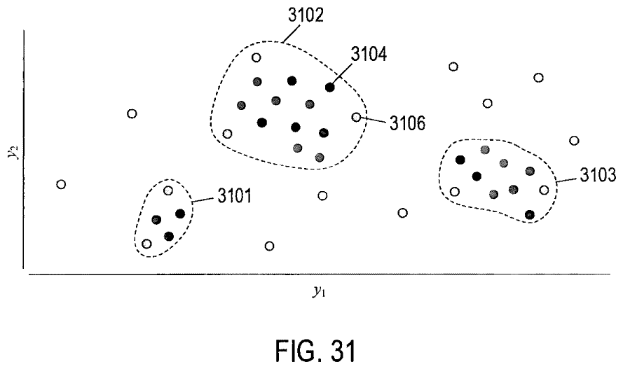

The operations manager 1330 identifies clusters of points in the map of applications based on the minimum number of points MinPts and the radius ∈. FIG. 31 shows an example plot of three clusters of two-dimensional points 3101-3103. Each cluster contains core points identified by solid dots, such as solid dot 3104, and border points identified by gray shaded dots, such as gray shaded dot 3106. Open dots, such as open dot 3108, represent points identified as noise. For each cluster, the operations manager 1330 adds a corresponding cluster label to each of the probability distributions in the data frame 2102.

HDBSCAN is an algorithm that performs density-based clustering, as described above, across different values of the radius ∈. This process is equivalent to finding the connected components of the mutual reachability graphs for the different values of the radius ∈. To do this efficiently. HDBSCAN extracts a minimum spanning tree (“MST”) from a fully-connected mutual reachability graph, then cuts the edges with the largest weight. The process and algorithm for executing HDBSCAN are provided by open source scikit-learn.org at cluster.HDBSCAN.

After clusters of points in the map of applications have been determined and labeled using HDBSCAN, the user can select one or more of the clusters to separately investigate for sub-clusters using t-SNE described above with reference to FIG. 26 with an L₁-distance given by:

$${dist}_{L 1} ( {P}_{i} , {P}_{j} ) = {\sum }_{n = 1}^{N} \vert {p}_{in} - {p}_{jn} \vert \qquad ( 9 )$$

In other words, t-SNE is applied to the probability distributions that correspond to a user selected cluster of points in the map of applications by replacing the Jaccard distance of Equation (3) with the L₁-distance in Equation (9). The process of HDBSCAN is applied to results of the t-SNE in order to discover and label sub-clusters of probability distributions that correspond to different instances or workloads with the application with probability distributions of the cluster identified using t-SNE with the Jaccard distance followed by HDBSCAN.

By separating out the applications associated with a cluster into sub-clusters of different instances of the application, an application owner or a systems administrator can isolate the different application instances of the same application and execute operations to optimize performance of the application instances. For example, VMs or containers used to execute an instance of the discovered application instance may be migrated to a server computer that has more computational resources than the server computer the VMs or containers are executing on, which improves the performance of the application instance. Migration can be performed using VMotion by VMware Inc.

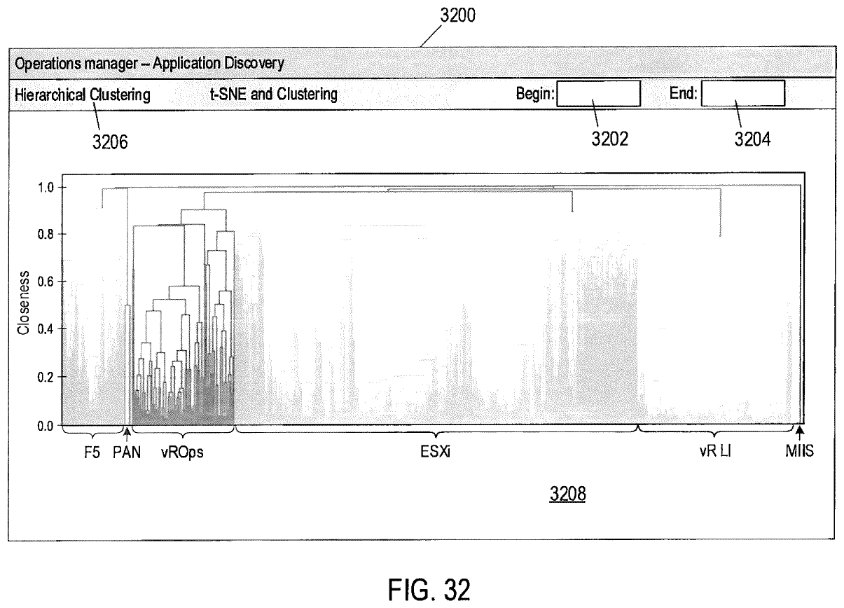

FIGS. 32-36 show an example of a graphical user interface (“GUI”) that is displayed on a display device and enables a user to execute the automated methods of AD described above. The GUI is described below with reference to results obtained from the methods described above applied to actual log messages generated by event sources of six applications monitored by Aria Ops, owned by VMware Inc., for a time period of one week. The probability distributions were generated over 4-hour subintervals of the one-week time period. The six applications that were monitored by Aria Ops are F5, PAN, vROps, ESXi, vRL1, and MIIIS.

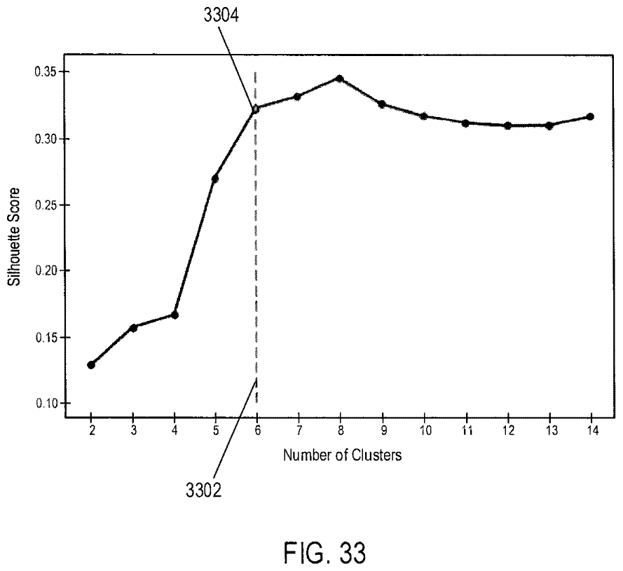

FIG. 32 shows an example GUI that displays options a user can select to perform AD based on the log messages of the six applications collected over the one-week time period. In this example, a user can input a start time and an end time of the time period in fields 3202 and 3204. The user has also selected “hierarchical clustering” by clicking on the button 3206. In response, the operations manager 1330 retrieves the log messages with time stamps between the start time 3202 and the end time 3205 from log files and performs hierarchical clustering on the log messages as described above with reference to FIGS. 20-25. A dendrogram of the actual results of hierarchical clustering performed on the log messages is shown in pane 3208. The results of hierarchical clustering reveal the clusters of probability distributions associated with the six applications identified with different shading: F5, PAN, vROps, ESXi, vRLI, and MIIIS. Silhouette scoring has been used to determine six clusters of probability distributions which correspond to the six applications. FIG. 33 shows the results of Silhouette scoring applied as described above with reference to Equations (4)-(7) and FIGS. 24L-24M. Dashed line 3302 identifies the number of clusters k=6 and corresponds to the Silhouette score 3304. The dendrogram illustrates how the six applications indicated by differently shaded trees are discriminated based on hierarchical clusters and Silhouette scoring. The largest cluster corresponds to ESXi applications.

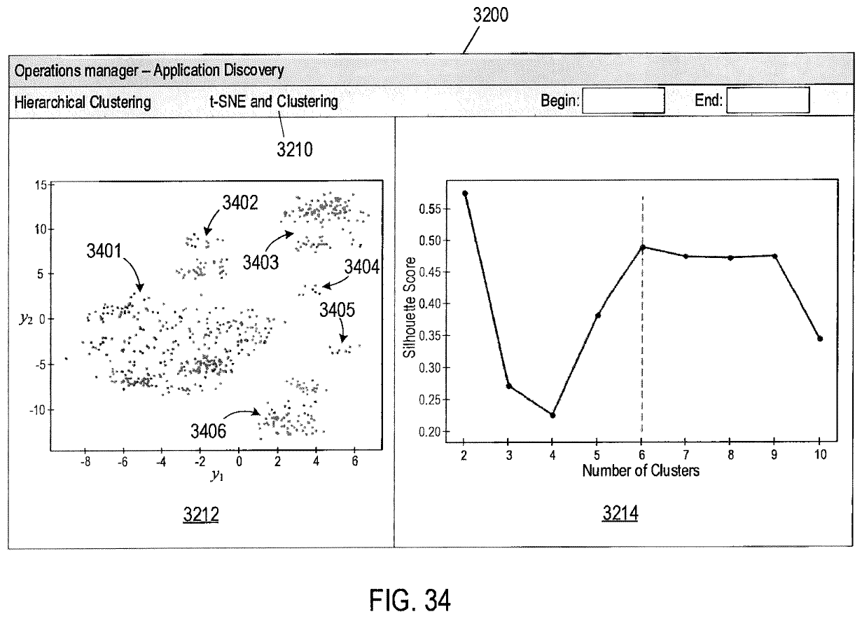

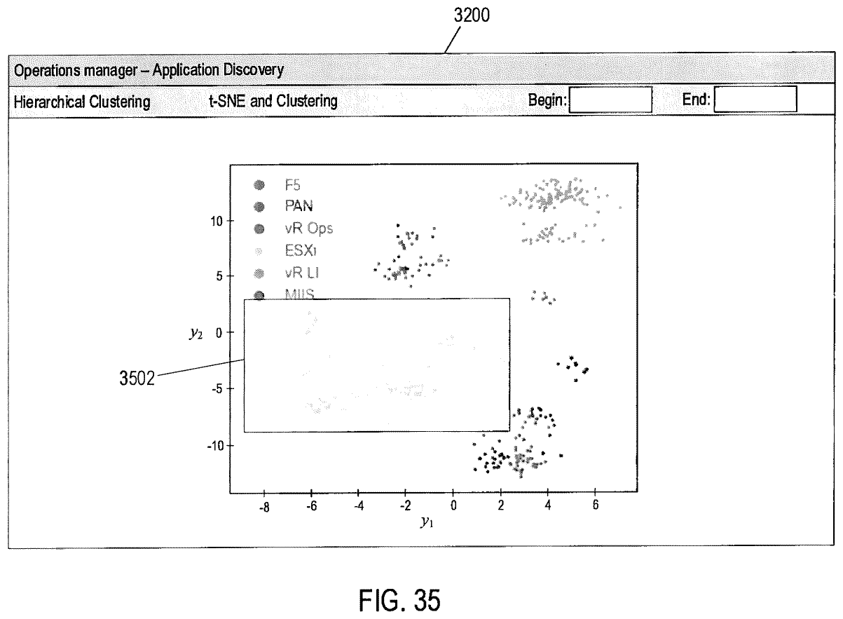

In FIG. 34, the user has selected the button 3210, which causes the operations manager 1330 to execute t-SNE and HDBSCAN clustering as described above. Pane 3212 shows a plot of the probability distributions of the six applications collected in the one-week time period projected into two dimensions using t-SNE with the Jaccard distance of Equation (3). The plot shows six clusters of points 3401-3406. HDSBCAN with Silhouette scoring is used to confirm the existence of the six clusters. Pane 3214 shows the results of HDSBCAN with Silhouette scoring for k=2, . . . , 10 clusters and suggests the maximum value of the Silhouette score is attained at k=2. However, the user can select k=6 for the second peak which matches the number of clusters shown in pane 3212. The operations manager 1330 displays the results of HDBSCAN and the results of the user having selected k=6 clusters identified by different labels and shading in the GUI 3200 of FIG. 35. The GUI 3200 enables the user to select the cluster of points in box 3502 that correspond to the ESXi application for additional clustering with t-SNE using the L₁-distance and HDBSCAN clustering.

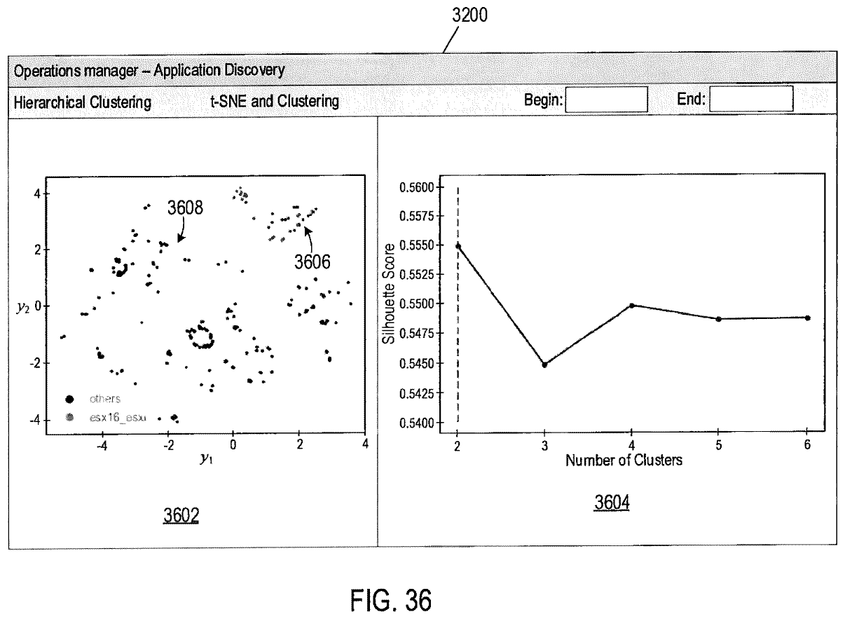

FIG. 36 shows the GUI 3200 with the results from applying t-SNE using the [symbol] -distance and HDBSCAN clustering with the probability distributions associated with the cluster of points in the box 3502. Pane 3602 shows a plot two clusters of points 3604 and 3606 identified by different shading. Pane 3604 shows a plot of Silhouette scores with the largest Silhouette score at k=2, indicating two clusters. Light shaded cluster of points 3606 correspond to probability distributions of an instance of an application denoted by ESX16_ESXi, which is a different instance of the applications ESXi represented by the cluster of black points 3608. In other words, the methods described above have discovered an instance of the application ESX16_ESXi, which was not apparent to the user beforehand in the cluster identified by box 3502 in FIG. 5. The user may direct the operations manager 1330 to automatically execute operations that improve the performance of the ESX16_ESXi application or just the other instances of the ESXi application. For example, the user can direct the operations manager 1330 to execute a script or run VMotion by VMware, Inc. to migrate the VMs or containers that run the ESX16_ESXi application to a server computer that has more computational resources than the server computer the VMs or containers are currently executing on, which improves the performance of the ESX16_ESXi application.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A computer-implemented process for application discovery from log messages generated by event sources of applications executing in a cloud infrastructure, the process comprising:
constructing a data frame of probability distributions of event types of the log messages generated by the event sources in a time period, each probability distribution containing the probabilities of event types generated by the event sources in a subinterval of the time period;
executing clustering techniques to determine clusters of the probability distributions of the data frame, each cluster corresponding one of the applications;
displaying a graphical user interface (“GUI”) in a display device, the GUI displaying the clusters in a two-dimensional map of the applications on the display device, enabling a user to select one of the clusters in the map that corresponds to one of the applications, and launch clustering of probability distributions of the user-selected cluster to discover two or more instances of the application; and
displaying the two or more instances of the application in the GUI.

2. The process of claim 1 wherein constructing the data frame of probability distributions of event types of the log messages comprises:
partitioning the time period into subintervals; and
for each subinterval,
extracting event types from the log messages with time stamps in the subinterval using regular expressions or Grok expressions,
incrementing a count of each event type generated in the subinterval,
computing a probability for each event type for the event sources as a fraction of the count of the event type divided by the total number of log messages generated in the subinterval, and
forming a probability distribution that contains the probabilities of the event types of the event sources.

3. The process of claim 1 wherein executing clustering techniques to determine clusters of the probability distributions of the data frame comprises:
executing hierarchical clustering and scoring on the data frame to determine the clusters of probability distributions, each cluster corresponding to one of the applications;
executing t-distributed stochastic neighbor embedding to project the probability distributions onto the two-dimensional map of applications based a Jaccard distance between pairs of probability distributions, each point of the map of applications corresponding to one of the probability distributions in the data frame; and
executing hierarchical density-based spatial clustering and scoring of the points of the map of applications to determine clusters of points, each cluster of points corresponding to one of the applications; and
labeling each cluster of points with a different label that identifies one of the applications.

4. The process of claim 3 wherein executing hierarchical clustering and scoring on the data frame to determine clusters of probability distributions comprises:
computing a distance matrix of distances calculated for each pair of probability distributions using the Jaccard distance with a similarity threshold;
performing agglomerative clustering to form a dendrogram of the probability distributions, each leaf of the dendrogram corresponding to one of the probability distributions;
executing scoring on the probability distributions of the dendrogram for different numbers of clusters to determine score for each of the different number of clusters; and
determining a threshold for cutting the dendrogram into the clusters of probability distributions based on the scores.

5. The process of claim 1 wherein clustering of probability distributions of the user-selected cluster to identify two or more instances of the applications comprises:
executing t-distributed stochastic neighbor embedding to project the probability distributions of the user-selected cluster onto a two-dimensional map of the application based L₁-distance between pairs of the probability distributions of the user-selected cluster; and
identifying two or more sub-clusters of the map of application as corresponding to the two or more instances of the application.

6. The process of claim 1 further comprising automatically executing operations that improve performance of at least one of the two or more instances of the application, the operations including migrating the instance of the application to a server computer that has more computational resources than the server computer the instance of the application is executing on.

7. A computer system for application discovery from log messages generated by event sources of applications executing in a cloud infrastructure, the computer system comprising:
a display device;
one or more processors;
one or more data-storage devices; and
machine-readable instructions stored in the one or more data-storage devices that when executed using the one or more processors control the system to perform operations comprising:
constructing a data frame of probability distributions of event types of the log messages generated by the event sources in a time period, each probability distribution containing the probabilities of event types generated by the event sources in a subinterval of the time period;
executing clustering techniques to determine clusters of the probability distributions of the data frame, each cluster corresponding one of the applications;
displaying a graphical user interface (“GUI”) in a display device, the GUI displaying the clusters in a two-dimensional map of the applications on the display device, enabling a user to select one of the clusters in the map that corresponds to one of the applications, and launch clustering of probability distributions of the user-selected cluster to discover two or more instances of the application; and
displaying the two or more instances of the application in the GUI.

8. The system of claim 7 wherein constructing the data frame of probability distributions of event types of the log messages comprises:
partitioning the time period into subintervals; and
for each subinterval,
extracting event types from the log messages with time stamps in the subinterval using regular expressions or Grok expressions,
incrementing a count of each event type generated in the subinterval,
computing a probability for each event type for the event sources as a fraction of the count of the event type divided by the total number of log messages generated in the subinterval, and
forming a probability distribution that contains the probabilities of the event types of the event sources.

9. The system of claim 7 wherein executing clustering techniques to determine clusters of the probability distributions of the data frame comprises:
executing hierarchical clustering and scoring on the data frame to determine the clusters of probability distributions, each cluster corresponding to one of the applications;
executing t-distributed stochastic neighbor embedding to project the probability distributions onto the two-dimensional map of applications based a Jaccard distance between pairs of probability distributions, each point of the map of applications corresponding to one of the probability distributions in the data frame; and
executing hierarchical density-based spatial clustering and scoring of the points of the map of applications to determine clusters of points, each cluster of points corresponding to one of the applications; and
labeling each cluster of points with a different label that identifies one of the applications.

10. The system of claim 9 wherein executing hierarchical clustering and scoring on the data frame to determine clusters of probability distributions comprises:
computing a distance matrix of distances calculated for each pair of probability distributions using the Jaccard distance with a similarity threshold;
performing agglomerative clustering to form a dendrogram of the probability distributions, each leaf of the dendrogram corresponding to one of the probability distributions;
executing scoring on the probability distributions of the dendrogram for different numbers of clusters to determine score for each of the different number of clusters; and
determining a threshold for cutting the dendrogram into the clusters of probability distributions based on the scores.

11. The system of claim 7 wherein clustering of probability distributions of the user-selected cluster to identify two or more instances of the applications comprises:
executing t-distributed stochastic neighbor embedding to project the probability distributions of the user-selected cluster onto a two-dimensional map of the application based Lᵢ-distance between pairs of the probability distributions of the user-selected cluster, and
identifying two or more sub-clusters of the map of application as corresponding to the two or more instances of the application.

12. The system of claim 7 further comprising automatically executing operations that improve performance of at least one of the two or more instances of the application, the operations including migrating the instance of the application to a server computer that has more computational resources than the server computer the instance of the application is executing on.

13. A non-transitory computer-readable medium having instructions encoded thereon for enabling one or more processors of a computer system to perform operations comprising:
constructing a data frame of probability distributions of event types of the log messages generated by the event sources in a time period, each probability distribution containing the probabilities of event types generated by the event sources in a subinterval of the time period;
executing clustering techniques to determine clusters of the probability distributions of the data frame, each cluster corresponding one of the applications;
displaying a graphical user interface (“GUI”) in a display device, the GUI displaying the clusters in a two-dimensional map of the applications on the display device, enabling a user to select one of the clusters in the map that corresponds to one of the applications, and launch clustering of probability distributions of the user-selected cluster to discover two or more instances of the application; and
displaying the two or more instances of the application in the GUI.

14. The medium of claim 13 wherein constructing the data frame of probability distributions of event types of the log messages comprises:
partitioning the time period into subintervals; and
for each subinterval,
extracting event types from the log messages with time stamps in the subinterval using regular expressions or Grok expressions,
incrementing a count of each event type generated in the subinterval,
computing a probability for each event type for the event sources as a fraction of the count of the event type divided by the total number of log messages generated in the subinterval, and
forming a probability distribution that contains the probabilities of the event types of the event sources.

15. The medium of claim 13 wherein executing clustering techniques to determine clusters of the probability distributions of the data frame comprises:
executing hierarchical clustering and scoring on the data frame to determine the clusters of probability distributions, each cluster corresponding to one of the applications;
executing t-distributed stochastic neighbor embedding to project the probability distributions onto the two-dimensional map of applications based a Jaccard distance between pairs of probability distributions, each point of the map of applications corresponding to one of the probability distributions in the data frame; and
executing hierarchical density-based spatial clustering and scoring of the points of the map of applications to determine clusters of points, each cluster of points corresponding to one of the applications; and
labeling each cluster of points with a different label that identifies one of the applications.

16. The medium of claim 13 wherein executing hierarchical clustering and scoring on the data frame to determine clusters of probability distributions comprises:
computing a distance matrix of distances calculated for each pair of probability distributions using the Jaccard distance with a similarity threshold;
performing agglomerative clustering to form a dendrogram of the probability distributions, each leaf of the dendrogram corresponding to one of the probability distributions;
executing scoring on the probability distributions of the dendrogram for different numbers of clusters to determine score for each of the different number of clusters; and
determining a threshold for cutting the dendrogram into the clusters of probability distributions based on the scores.

17. The medium of claim 13 wherein clustering of probability distributions of the user-selected cluster to identify two or more instances of the applications comprises:
executing t-distributed stochastic neighbor embedding to project the probability distributions of the user-selected cluster onto a two-dimensional map of the application based L₁-distance between pairs of the probability distributions of the user-selected cluster, and
identifying two or more sub-clusters of the map of application as corresponding to the two or more instances of the application.

18. The medium of claim 13 further comprising automatically executing operations that improve performance of at least one of the two or more instances of the application, the operations including migrating the instance of the application to a server computer that has more computational resources than the server computer the instance of the application is executing on.
